(19) United States
(12) Patent Application Publication
(10) Pub. No.: US 2013/0121278 A1
(43) Pub. Date: May 16, 2013

(54) METHOD AND APPARATUS FOR ALLOCATING RESOURCES IN A WIRELESS COMMUNICATION SYSTEM

(71) Applicants: Min Seok Noh, Anyang-si (KR); Seung Hee Han, Anyang-si (KR); Jae Hoon Chung, Anyang-si (KR)

(72) Inventors: Min Seok Noh, Anyang-si (KR); Seung Hee Han, Anyang-si (KR); Jae Hoon Chung, Anyang-si (KR)

(73) Assignee: LG ELECTRONICS INC., Seoul (KR)

(21) Appl. No.: 13/701,353

(22) PCT Filed: Jun. 1, 2011
(86) PCT No.: PCT/KR2011/004016

§ 371 Date: Dec. 27, 2012

Related U.S. Application Data
(60) Provisional application No. 61/350,403, filed on Jun. 1, 2010.
(60) Provisional application No. 61/352,391, filed on Jun. 8, 2010.
(60) Provisional application No. 61/353,612, filed on Jun. 10, 2010.
(60) Provisional application No. 61/354,707, filed on Jun. 15, 2010.
(60) Provisional application No. 61/357,104, filed on Jun. 22, 2010.
(60) Provisional application No. 61/357,530, filed on Jun. 23, 2010.

(51) Int. Cl. H04W 72/04

(52) U.S. Cl. CPC H04W 72/04
USPC 370/329

(57) ABSTRACT

The present invention provides a method and apparatus for allocating uplink resources in a wireless communication system. A base station transmits uplink resource allocation information to a terminal in order to allocate a plurality of clusters that are dispersed in a frequency domain to uplink resources, and receives data on the plurality of clusters. The plurality of clusters is allocated on the bases of at least one of the following: location of each cluster in the frequency domain and gap between the plurality of clusters.

### BACKGROUND OF THE INVENTION

1. Field of the Invention

The present invention relates to wireless communication, and more particularly, to a method and apparatus for allocating resources in a wireless communication system.

2. Related Art

Effective transmission/reception methods and utilizations have been proposed for a broadband wireless communication system to maximize efficiency of radio resources. An orthogonal frequency division multiplexing (OFDM) system capable of reducing inter-symbol interference (ISI) with a low complexity is taken into consideration as one of next generation wireless communication systems. In the OFDM, a serially input data symbol is converted into N parallel data symbols, and is then transmitted by being carried on each of separated N subcarriers. The subcarriers maintain orthogonality in a frequency dimension. Each orthogonal channel experiences mutually independent frequency selective fading, and an interval of a transmitted symbol is increased, thereby minimizing inter-symbol interference.

When a system uses the OFDM as a modulation scheme, orthogonal frequency division multiple access (OFDMA) is a multiple access scheme in which multiple access is achieved by independently providing some of available subcarriers to a plurality of users. In the OFDMA, frequency resources (i.e., subcarriers) are provided to the respective users, and the respective frequency resources do not overlap with one another in general since they are independently provided to the plurality of users. Consequently, the frequency resources are allocated to the respective users in a mutually exclusive manner. In an OFDMA system, frequency diversity for multiple users can be obtained by using frequency selective scheduling, and subcarriers can be allocated variously according to a permutation rule for the subcarriers. In addition, a spatial multiplexing scheme using multiple antennas can be used to increase efficiency of a spatial domain.

MIMO technology can be used to improve the efficiency of data transmission and reception using multiple transmission antennas and multiple reception antennas. MIMO technology may include a space frequency block code (SFBC), a space time block code (STBC), a cyclic delay diversity (CDD), a frequency switched transmit diversity (FSTD), a time switched transmit diversity (TSTD), a precoding vector switching (PVS), spatial multiplexing (SM) for implementing diversity. An MIMO channel matrix according to the number of reception antennas and the number of transmission antennas can be decomposed into a number of independent channels. Each of the independent channels is called a layer or stream. The number of layers is called a rank.

In order to obtain a frequency diversity gain in 3^{rd} generation partnership project (3GPP) long term evolution advanced (LTE-A), distributed or non-contiguous uplink resource allocation can be performed for a physical uplink shared channel (PUSCH). The LTE-A distributed uplink resource allocation needs to support dynamic switching with the conventional LTE rel-8/9 single uplink resource allocation.

There is a need for a method of effectively allocating distributed uplink resources.

### SUMMARY OF THE INVENTION

The present invention provides a method and apparatus for allocating resources in a wireless communication system.

In an aspect, a method for allocating an uplink resource in a wireless communication system is provided. The method includes allocating a plurality of clusters which are distributed in a frequency domain to uplink resources by transmitting uplink resource allocation information to a terminal, and receiving data through the plurality of clusters. The plurality of clusters is allocated on the basis of at least one of a position of each of the plurality of clusters in the frequency domain and a gap between the plurality of clusters.

The uplink resource allocation information may be included in downlink control information (DCI) transmitted through a physical downlink control channel (PDCCH).

A resource allocation field of the DCI format may include a resource indication value (RIV), and the RIV may be determined on the basis of at least one of the position of each of the plurality of clusters and the gap between the plurality of clusters.

The gap between the plurality of clusters may be uniform.

The plurality of clusters may be respectively included in a plurality of resource groups, and the plurality of resource groups may be allocated in a uniform specific gap.

The plurality of clusters may be respectively included in a plurality of resource groups, the plurality of resource groups may be included in a plurality of super groups, and the plurality of super groups may be allocated in a uniform specific gap.

Clusters included in any one super group among the plurality of super groups may start at the same position in the respective resource groups included in the any one super group.

Clusters included in any one super group among the plurality of super groups may have the same length.

Clusters included in different super groups among the plurality of super groups may have different lengths.

The gap between the plurality of clusters may be indicated on the basis of a position of any one reference cluster among the plurality of clusters and a position of a cluster allocated next to the reference cluster.

The number of the plurality of clusters may be 2.

The plurality of clusters may be allocated on the basis of length of each of the plurality of clusters.

In another aspect, a method of transmitting data in a wireless communication system is provided. The method includes receiving uplink resource allocation information from a base station, and transmitting data through a plurality of distributed clusters allocated on the basis of the uplink resource allocation information. The plurality of clusters is allocated on the basis of at least one of a position of each of the plurality of clusters in a frequency domain and a gap between the plurality of clusters.

The uplink resource allocation information may be included in downlink control information (DCI) transmitted on a physical downlink control channel (PDCCH).

Distributed uplink resources can be effectively allocated.

### BRIEF DESCRIPTION OF THE DRAWINGS

FIG. 1 shows a wireless communication system.

FIG. 2 shows the structure of a radio frame in 3GPP LTE.

FIG. 3 shows an example of a resource grid of a single downlink slot.

FIG. 4 shows the structure of a downlink subframe.

FIG. 5 shows the structure of an uplink subframe.

FIG. 6 shows an example of the structure of a transmitter in an SC-FDMA system.

FIG. 7 shows an example of a scheme in which the subcarrier mapper maps the complex-valued symbols to the respective subcarriers of the frequency domain.

FIG. 8 shows an example of the structure of a reference signal transmitter for demodulation.

FIG. 9 shows examples of a subframe through which a reference signal is transmitted. The structure of a subframe in FIG. 9(a) shows a case of a normal CP.

FIG. 10 shows an example of a transmitter using the clustered DFT-s OFDM transmission scheme.

FIG. 11 shows another example of a transmitter using the clustered DFT-s OFDM transmission scheme.

FIG. 12 is another example of a transmitter using the clustered DFT-s OFDM transmission scheme.

FIG. 13 shows an exemplary case of allocating distributed uplink resources.

FIG. 14 shows an example of distributed uplink resource allocation according to the proposed resource allocation method.

FIG. 15 shows another example of distributed uplink resource allocation according to the proposed resource allocation method.

FIG. 16 to FIG. 18 shows another example of distributed uplink resource allocation according to the proposed resource allocation method.

FIG. 19 shows the proposed resource allocation method according to an embodiment of the present invention.

FIG. 20 shows the proposed data transmission method according to an embodiment of the present invention.

FIG. 21 shows a case in which, when two distributed clusters are allocated, the clusters have the same length.

FIG. 22 shows a frequency domain in which two clusters are allocated.

FIG. 23 shows a frequency domain in which two clusters are allocated.

FIG. 24 is a block diagram showing wireless communication system to implement an embodiment of the present invention.

### DESCRIPTION OF EXEMPLARY EMBODIMENTS

The following technique may be used for various wireless communication systems such as code division multiple access (CDMA), a frequency division multiple access (FDMA), time division multiple access (TDMA), orthogonal frequency division multiple access (OFDMA), single carrier-frequency division multiple access (SC-FDMA), and the like. The CDMA may be implemented as a radio technology such as universal terrestrial radio access (UTRA) or CDMA2000. The TDMA may be implemented as a radio technology such as a global system for mobile communications (GSM)/general packet radio service (GPRS)/enhanced data rates for GSM evolution (EDGE). The OFDMA may be implemented by a radio technology such as institute of electrical and electronics engineers (IEEE) 802.11 (Wi-Fi), IEEE 802.16 (WiMAX), IEEE 802.20, E-UTRA (evolved UTRA), and the like. WEE 802.16m, an evolution of IEEE 802.16e, provides backward compatibility with a system based on IEEE 802.16e. The UTRA is part of a universal mobile telecommunications system (UMTS). 3GPP (3rd generation partnership project) LTE (long term evolution) is part of an evolved UMTS (E-UMTS) using the E-UTRA, which employs the OFDMA in downlink and the SC-FDMA in uplink. LTE-A (advanced) is an evolution of 3GPP LTE.

Hereinafter, for clarification, LTE-A will be largely described, but the technical concept of the present invention is not meant to be limited thereto.

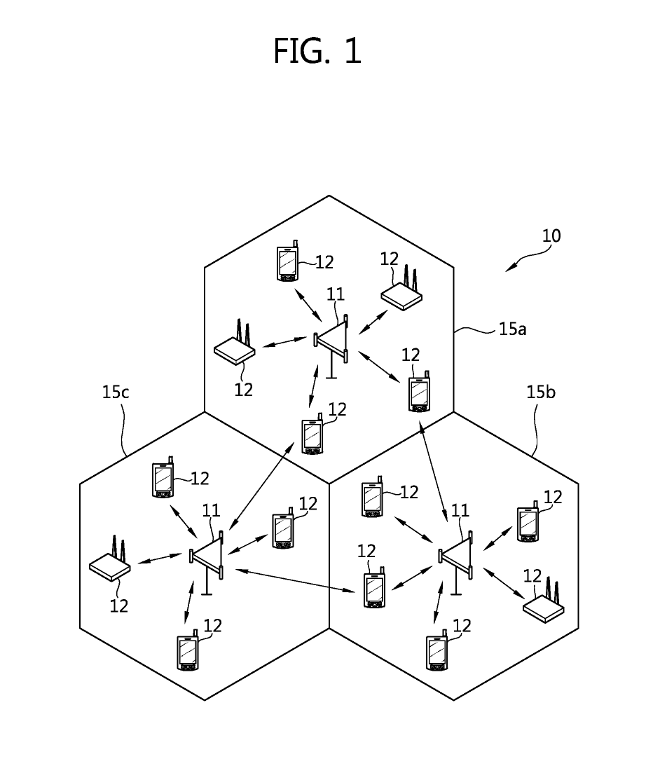

FIG. 1 shows a wireless communication system.

The wireless communication system 10 includes at least one base station (BS) 11. Respective BSs 11 provide a communication service to particular geographical areas 15a, 15b, and 15c (which are generally called cells). Each cell may be divided into a plurality of areas (which are called sectors). A user equipment (UE) 12 may be fixed or mobile and may be referred to by other names such as MS (mobile station), MT (mobile terminal), UT (user terminal), SS (subscriber station), wireless device, PDA (personal digital assistant), wireless modem, handheld device. The BS 11 generally refers to a fixed station that communicates with the UE 12 and may be called by other names such as eNB (evolved-NodeB), BTS (base transceiver system), access point (AP), etc.

In general, a UE belongs to one cell, and the cell to which a UE belongs is called a serving cell. A BS providing a communication service to the serving cell is called a serving BS. The wireless communication system is a cellular system, so a different cell adjacent to the serving cell exists. The different cell adjacent to the serving cell is called a neighbor cell. A BS providing a communication service to the neighbor cell is called a neighbor BS. The serving cell and the neighbor cell are relatively determined based on a UE.

This technique can be used for downlink or uplink. In general, downlink refers to communication from the BS 11 to the UE 12, and uplink refers to communication from the UE 12 to the BS 11. In downlink, a transmitter may be part of the BS 11 and a receiver may be part of the UE 12. In uplink, a transmitter may be part of the UE 12 and a receiver may be part of the BS 11.

The wireless communication system may be any one of a multiple-input multiple-output (MIMO) system, a multiple-input single-output (MISO) system, a single-input single-output (SISO) system, and a single-input multiple-output (SIMO) system. The MIMO system uses a plurality of transmission antennas and a plurality of reception antennas. The MISO system uses a plurality of transmission antennas and a single reception antenna. The SISO system uses a single transmission antenna and a single reception antenna. The SIMO system uses a single transmission antenna and a plurality of reception antennas. Hereinafter, a transmission antenna refers to a physical or logical antenna used for transmitting a signal or a stream, and a reception antenna refers to a physical or logical antenna used for receiving a signal or a stream.

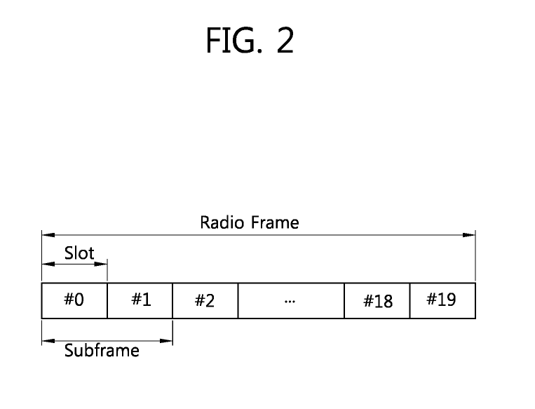

FIG. 2 shows the structure of a radio frame in 3GPP LTE.

It may be referred to Paragraph 5 of “Technical Specification Group Radio Access Network; Evolved Universal Terrestrial Radio Access (E-UTRA); Physical channels and modulation (Release 8)” to 3GPP (3rd generation partnership project) TS 36.211 V8.2.0 (2008-03). Referring to FIG. 2, the radio frame includes 10 subframes, and one subframe includes two slots. The slots in the radio frame are numbered by #0 to #19. A time taken for transmitting one subframe is called a transmission time interval (TTI). The TTI may be a scheduling unit for a data transmission. For example, a radio frame may have a length of 10 ms, a subframe may have a length of 1 ms, and a slot may have a length of 0.5 ms.

One slot includes a plurality of orthogonal frequency division multiplexing (OFDM) symbols in a time domain and a plurality of subcarriers in a frequency domain. Since 3GPP LTE uses OFDMA in downlink, the OFDM symbols are used to express a symbol period. The OFDM symbols may be called by other names depending on a multiple-access scheme. For example, when a single carrier frequency division multiple access (SC-FDMA) is in use as an uplink multi-access scheme, the OFDM symbols may be called SC-FDMA symbols. A resource block (RB), a resource allocation unit, includes a plurality of continuous subcarriers in a slot. The structure of the radio frame is merely an example. Namely, the number of subframes included in a radio frame, the number of slots included in a subframe, or the number of OFDM symbols included in a slot may vary.

3GPP LTE defines that one slot includes seven OFDM symbols in a normal cyclic prefix (CP) and one slot includes six OFDM symbols in an extended CP.

The wireless communication system may be divided into a frequency division duplex (FDD) scheme and a time division duplex (TDD) scheme. According to the FDD scheme, an uplink transmission and a downlink transmission are made at different frequency bands. According to the TDD scheme, an uplink transmission and a downlink transmission are made during different periods of time at the same frequency band. A channel response of the TDD scheme is substantially reciprocal. This means that a downlink channel response and an uplink channel response are almost the same in a given frequency band. Thus, the TDD-based wireless communication system is advantageous in that the downlink channel response can be obtained from the uplink channel response. In the TDD scheme, the entire frequency band is time-divided for uplink and downlink transmissions, so a downlink transmission by the BS and an uplink transmission by the UE can be simultaneously performed. In a TDD system in which an uplink transmission and a downlink transmission are discriminated in units of subframes, the uplink transmission and the downlink transmission are performed in different subframes.

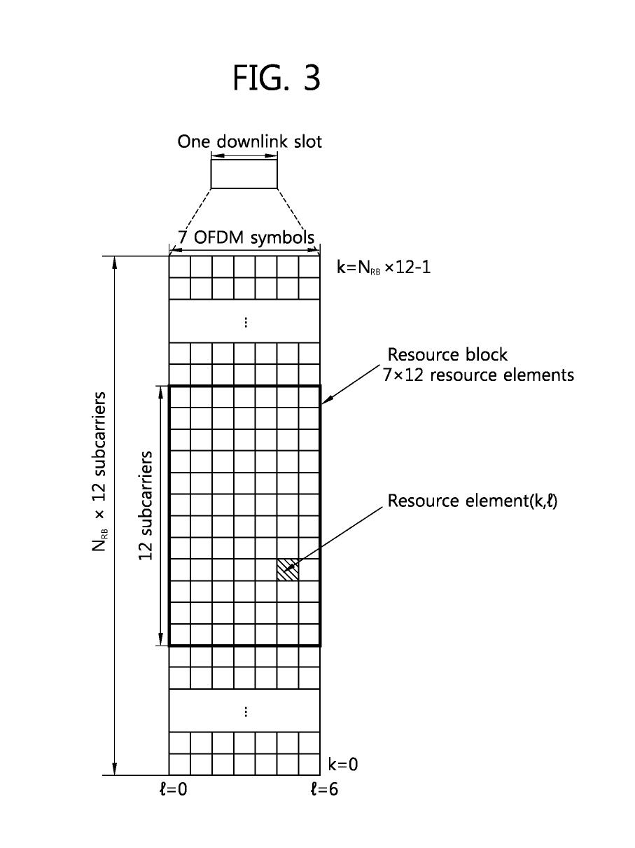

FIG. 3 shows an example of a resource grid of a single downlink slot.

A downlink slot includes a plurality of OFDM symbols in the time domain and N_{RB} number of resource blocks (RBs) in the frequency domain. The N_{RB} number of resource blocks included in the downlink slot is dependent upon a downlink transmission bandwidth set in a cell. For example, in an LTE system, N_{RB} may be any one of 60 to 110. One resource block includes a plurality of subcarriers in the frequency domain. An uplink slot may have the same structure as that of the downlink slot.

Each element on the resource grid is called a resource element. The resource elements on the resource grid can be discriminated by a pair of indexes (k,l) in the slot. Here, k (k=0, . . . , N_{RB}×12−1) is a subcarrier index in the frequency domain, and l is an OFDM symbol index in the time domain.

Here, it is illustrated that one resource block includes 7×12 resource elements made up of seven OFDM symbols in the time domain and twelve subcarriers in the frequency domain, but the number of OFDM symbols and the number of subcarriers in the resource block are not limited thereto. The number of OFDM symbols and the number of subcarriers may vary depending on the length of a cyclic prefix (CP), frequency spacing, and the like. For example, in case of a normal CP, the number of OFDM symbols is 7, and in case of an extended CP, the number of OFDM symbols is 6. One of 128, 256, 512, 1024, 1536, and 2048 may be selectively used as the number of subcarriers in one OFDM symbol.

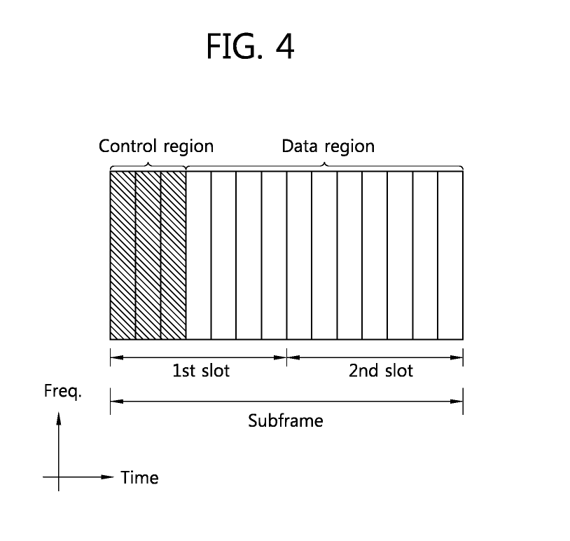

FIG. 4 shows the structure of a downlink subframe.

A downlink subframe includes two slots in the time domain, and each of the slots includes seven OFDM symbols in the normal CP. First three OFDM symbols (maximum four OFDM symbols with respect to a 1.4 MHz bandwidth) of a first slot in the subframe corresponds to a control region to which control channels are allocated, and the other remaining OFDM symbols correspond to a data region to which a physical downlink shared channel (PDSCH) is allocated.

The PDCCH may carry a transmission format and a resource allocation of a downlink shared channel (DL-SCH), resource allocation information of an uplink shared channel (UL-SCH), paging information on a PCH, system information on a DL-SCH, a resource allocation of an higher layer control message such as a random access response transmitted via a PDSCH, a set of transmission power control commands with respect to individual UEs in a certain UE group, an activation of a voice over internet protocol (VoIP), and the like. A plurality of PDCCHs may be transmitted in the control region, and a UE can monitor a plurality of PDCCHs. The PDCCHs are transmitted on one or an aggregation of a plurality of consecutive control channel elements (CCE). The CCE is a logical allocation unit used to provide a coding rate according to the state of a wireless channel. The CCE corresponds to a plurality of resource element groups. The format of the PDCCH and an available number of bits of the PDCCH are determined according to an associative relation between the number of the CCEs and a coding rate provided by the CCEs.

The BS determines a PDCCH format according to a DCI to be transmitted to the UE, and attaches a cyclic redundancy check (CRC) to the DCI. A unique radio network temporary identifier (RNTI) is masked on the CRC according to the owner or the purpose of the PDCCH. In case of a PDCCH for a particular UE, a unique identifier, e.g., a cell-RNTI (C-RNTI), of the UE, may be masked on the CRC. Or, in case of a PDCCH for a paging message, a paging indication identifier, e.g., a paging-RNTI (P-RNTI), may be masked on the CRC. In case of a PDCCH for a system information block (SIB), a system information identifier, e.g., a system information-RNTI (SI-RNTI), may be masked on the CRC. In order to indicate a random access response, i.e., a response to a transmission of a random access preamble of the UE, a random access-RNTI (RA-RNTI) may be masked on the CRC.

The DCI to which the CRC is attached may be transmitted by using channel coding and rate matching.

For example, a DCI format 0 may include the following fields. The DCI format 0 may be used for scheduling of a physical uplink shared channel (PUSCH).
Flag field for DCI format 0/1A identification: It may indicate DCI format 0 if a flag value is 0, and may indicate DCI format A if the flag value is 1.
Frequency hopping flag field: 1 bit
Resource block assignment and hopping resource allocation field
Modulation and coding scheme and redundancy version field: 5 bits
New data indicator field: 1 bit
TPC command field for scheduled PUSCH: 2 bits
Cyclic shift field for DMRS: 3 bits
UL index field: 2 bits
Downlink assignment index (DAI) field: 2 bits
CQI request field: 1 bit

Each of the fields may be mapped in the order in which it appears in the description above. That is, the flag field for DCI format 0/1A identification may be mapped to a first part of information bits, and the remaining fields may be mapped in sequence. In addition, a most significant bit (MSB) of each field may be mapped to the first part of information bits. Meanwhile, if a size of the DCI format 0 is less than a size of the DCI format 1A, a zero bit may be padded until the size of the DCI format 0 becomes equal to the size of the DCI format 1A.

The DCI format 1A may include the following fields. The DCI format 1A may be used for scheduling of one PDSCH codeword.
Flag field for DCI format 0/1A identification: It may indicate DCI format 0 if a flag value is 0, and may indicate DCI format A if the flag value is 1.
Localized/distributed virtual resource block (VRB) allocation flag field: 1 bit
Resource block assignment field
Modulation and coding scheme field: 5 bits
Hybrid automatic repeat request (HARQ) process number field: 3 bits or 4 bits
New data indicator field: 1 bit
Redundancy version field: 2 bits
TPC command field for PUCCH: 2 bits
Downlink assignment index (DAI) field: 2 bits

If a size of the DCI format 1A is less than a size of the DCI format 0, a zero bit may be padded until the size of the DCI format 1A becomes equal to the size of the DCI format 0. In addition, if the DCI format 1A is scrambled with RA-RNTI, P-RNTI or SI-RNTI, the HARQ process number field and the DAI field of the DCI format 1A may be reserved.

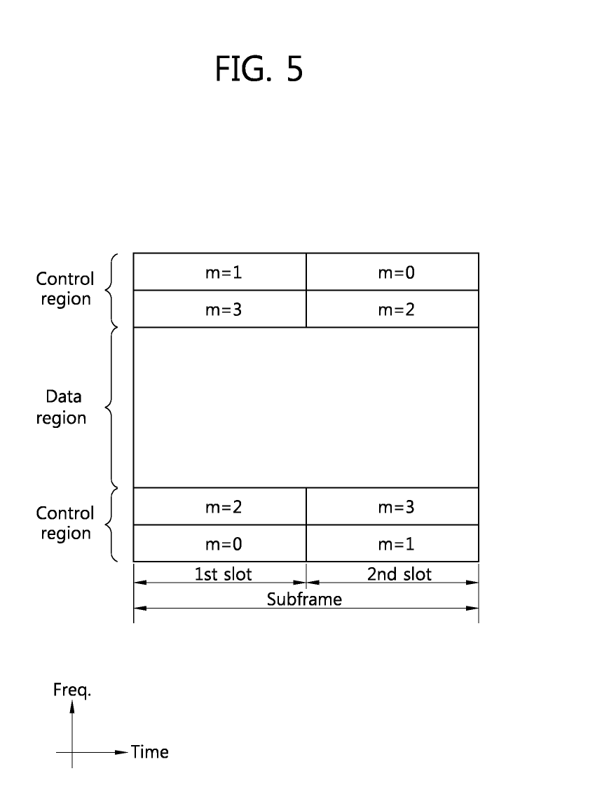

FIG. 5 shows the structure of an uplink subframe.

An uplink subframe may be divided into a control region and a data region in the frequency domain. A physical uplink control channel (PUCCH) for transmitting uplink control information is allocated to the control region. A physical uplink shared channel (PUSCH) for transmitting data is allocated to the data region. If indicated by a higher layer, the user equipment may support simultaneous transmission of the PUCCH and the PUSCH.

The PUCCH for one UE is allocated in an RB pair. RBs belonging to the RB pair occupy different subcarriers in each of a 1^{st} slot and a 2^{nd} slot. A frequency occupied by the RBs belonging to the RB pair allocated to the PUCCH changes at a slot boundary. This is called that the RB pair allocated to the PUCCH is frequency-hopped at a slot boundary. Since the UE transmits UL control information over time through different subcarriers, a frequency diversity gain can be obtained. In the figure, m is a location index indicating a logical frequency-domain location of the RB pair allocated to the PUCCH in the subframe.

Uplink control information transmitted on the PUCCH may include a HARQ ACK/NACK, a channel quality indicator (CQI) indicating the state of a downlink channel, a scheduling request (SR) which is an uplink radio resource allocation request, and the like.

The PUSCH is mapped to a uplink shared channel (UL-SCH), a transport channel. Uplink data transmitted on the PUSCH may be a transport block, a data block for the UL-SCH transmitted during the TTI. The transport block may be user information. Or, the uplink data may be multiplexed data. The multiplexed data may be data obtained by multiplexing the transport block for the UL-SCH and control information. For example, control information multiplexed to data may include a CQI, a precoding matrix indicator (PMI), an HARQ, a rank indicator (RI), or the like. Or the uplink data may include only control information.

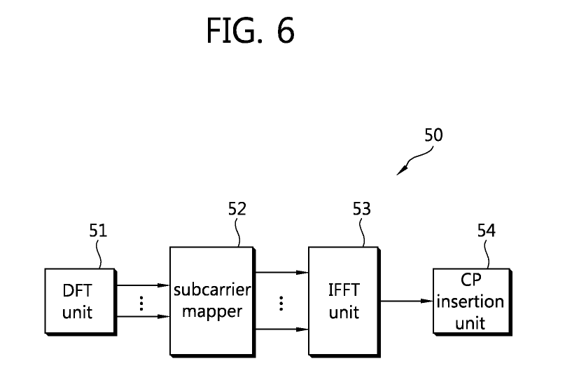

FIG. 6 shows an example of the structure of a transmitter in an SC-FDMA system.

Referring to FIG. 6, the transmitter 50 includes a discrete Fourier transform (DFT) unit 51, a subcarrier mapper 52, an inverse fast Fourier transform (IFFT) unit 53, and a cyclic prefix (CP) insertion unit 54. The transmitter 50 may include a scramble unit (not shown), a modulation mapper (not shown), a layer mapper (not shown), and a layer permutator (not shown), which may be placed in front of the DFT unit 51.

The DFT unit 51 outputs complex-valued symbols by performing DFT on input symbols. For example, when Ntx symbols are input (where Ntx is a natural number), a DFT size is Ntx. The DFT unit 51 may be called a transform precoder. The subcarrier mapper 52 maps the complex-valued symbols to the respective subcarriers of the frequency domain. The complex-valued symbols may be mapped to resource elements corresponding to a resource block allocated for data transmission. The subcarrier mapper 52 may be called a resource element mapper. The IFFT unit 53 outputs a baseband signal for data (that is, a time domain signal) by performing IFFT on the input symbols. The CP insertion unit 54 copies some of the rear part of the baseband signal for data and inserts the copied parts into the former part of the baseband signal for data. Orthogonality may be maintained even in a multi-path channel because inter-symbol interference (ISI) and inter-carrier interference (ICI) are prevented through CP insertion.

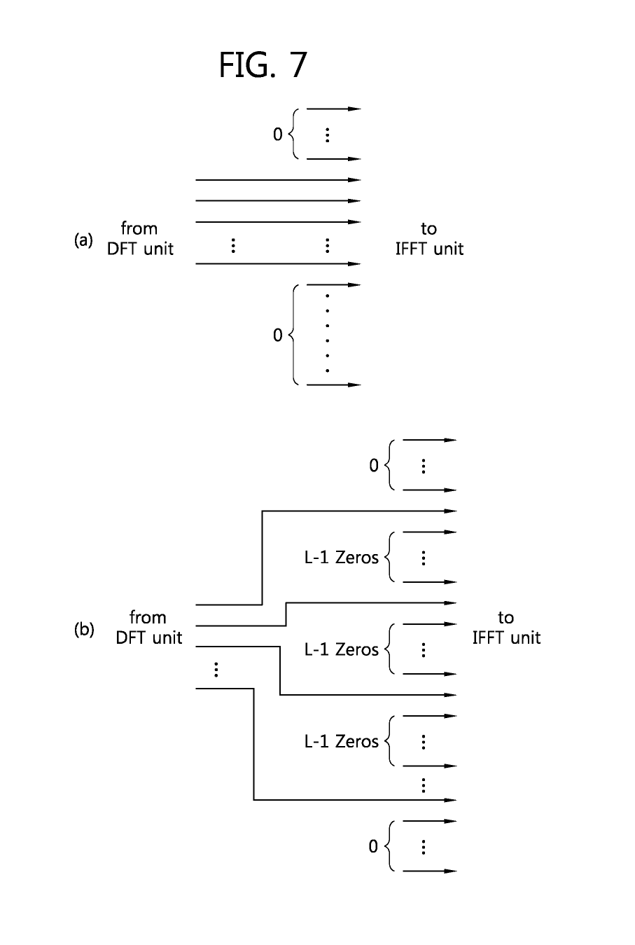

FIG. 7 shows an example of a scheme in which the subcarrier mapper maps the complex-valued symbols to the respective subcarriers of the frequency domain. Referring to FIG. 7(a), the subcarrier mapper maps the complex-valued symbols, outputted from the DFT unit, to subcarriers contiguous to each other in the frequency domain. ‘0’ is inserted into subcarriers to which the complex-valued symbols are not mapped. This is called localized mapping. In a 3GPP LTE system, a localized mapping scheme is used. Referring to FIG. 7(b), the subcarrier mapper inserts an (L−1) number of ‘0’ every two contiguous complex-valued symbols which are outputted from the DFT unit (L is a natural number). That is, the complex-valued symbols outputted from the DFT unit are mapped to subcarriers distributed at equal intervals in the frequency domain. This is called distributed mapping. If the subcarrier mapper uses the localized mapping scheme as in FIG. 7(a) or the distributed mapping scheme as in FIG. 7(b), a single carrier characteristic is maintained.

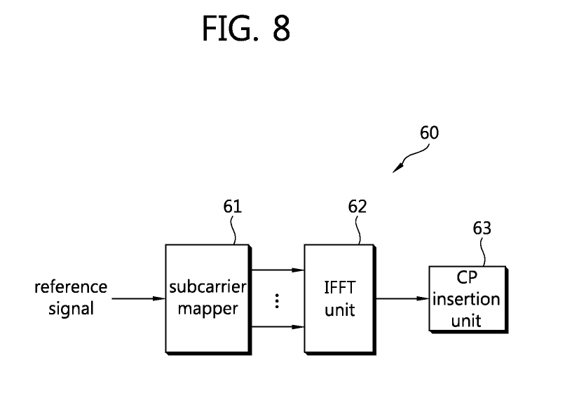

FIG. 8 shows an example of the structure of a reference signal transmitter for demodulation.

Referring to FIG. 8, the reference signal transmitter 60 includes a subcarrier mapper 61, an IFFT unit 62, and a CP insertion unit 63. Unlike the transmitter 50 of FIG. 6, in the reference signal transmitter 60, a reference signal is directly generated in the frequency domain without passing through the DFT unit 51 and then mapped to subcarriers through the subcarrier mapper 61. Here, the subcarrier mapper may map the reference signal to the subcarriers using the localized mapping scheme of FIG. 7(a).

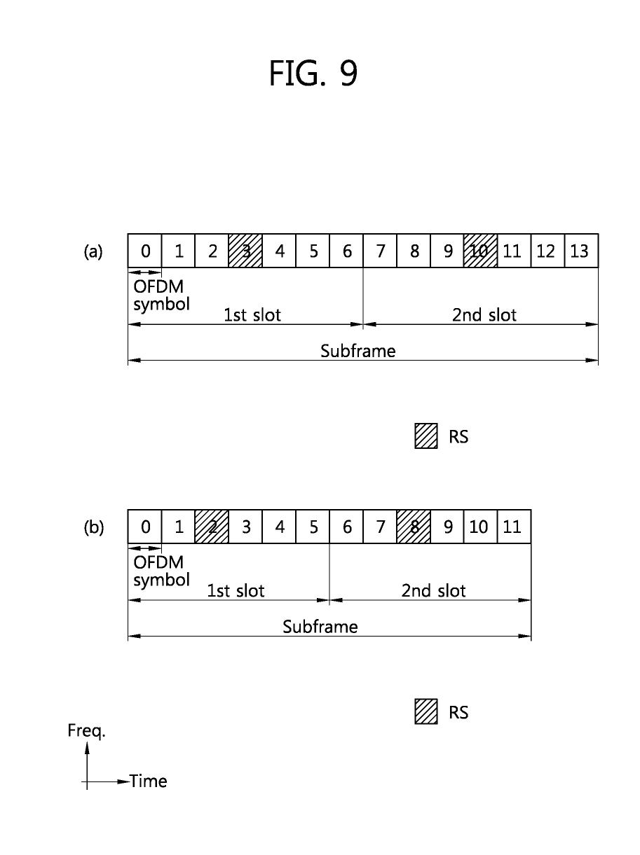

FIG. 9 shows examples of a subframe through which a reference signal is transmitted. The structure of a subframe in FIG. 9(a) shows a case of a normal CP. The subframe includes a first slot and a second slot. Each of the first slot and the second slot includes 7 OFDM symbols. The 14 OFDM symbols within the subframe are assigned respective symbol indices 0 to 13. Reference signals may be transmitted through the OFDM symbols having the symbol indices 3 and 10. The reference signals may be transmitted using a sequence. A Zadoff-Chu (ZC) sequence may be used as the reference signal sequence. A variety of ZC sequences may be generated according to a root index and a cyclic shift value. A BS may estimate the channels of a plurality of UEs through an orthogonal sequence or a quasi-orthogonal sequence by allocating different cyclic shift values to the UEs. The positions of the reference signals occupied in the two slots within the subframe in the frequency domain may be identical with each other or different from each other. In the two slots, the same reference signal sequence is used. Data may be transmitted through the remaining SC-FDMA symbols other than the SC-FDMA symbols through which the reference signals are transmitted. The structure of a subframe in FIG. 9(b) shows a case of an extended CP. The subframe includes a first slot and a second slot. Each of the first slot and the second slot includes 6 SC-FDMA symbols. The 12 SC-FDMA symbols within the subframe are assigned symbol indices 0 to 11. Reference signals are transmitted through the SC-FDMA symbols having the symbol indices 2 and 8. Data is transmitted through the remaining SC-FDMA symbols other than the SC-FDMA symbols through which the reference signals are transmitted.

Although not shown in FIG. 9, a sounding reference signal (SRS) may be transmitted through the OFDM symbols within the subframe. The SRS is a reference signal for UL scheduling which is transmitted from UE to a BS. The BS estimates a UL channel through the received SRS and uses the estimated UL channel in UL scheduling.

A clustered DFT-s OFDM transmission scheme is a modification of the existing SC-FDMA transmission scheme and is a method of dividing data symbols, subjected to a precoder, into a plurality of subblocks, separating the subblocks, and mapping the subblocks in the frequency domain.

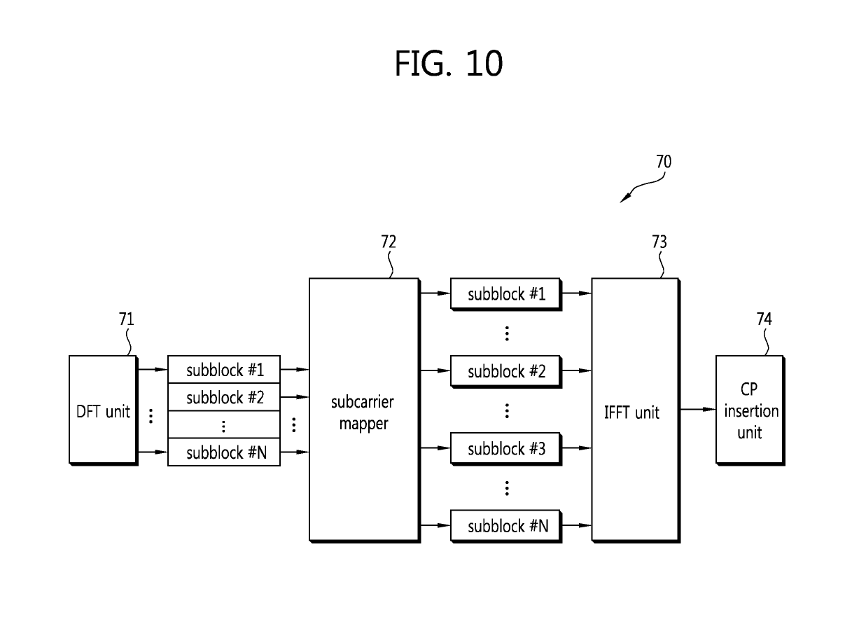

FIG. 10 shows an example of a transmitter using the clustered DFT-s OFDM transmission scheme. Referring to FIG. 10, the transmitter 70 includes a DFT unit 71, a subcarrier mapper 72, an IFFT unit 73, and a CP insertion unit 74. The transmitter 70 may further include a scramble unit (not shown), a modulation mapper (not shown), a layer mapper (not shown), and a layer permutator (not shown), which may be placed in front of the DFT unit 71.

Complex-valued symbols outputted from the DFT unit 71 are divided into N subblocks (N is a natural number). The N subblocks may be represented by a subblock #1, a subblock #2, . . . , a subblock #N. The subcarrier mapper 72 distributes the N subblocks in the frequency domain and maps the N subblocks to subcarriers. The NULL may be inserted every two contiguous subblocks. The complex-valued symbols within one subblock may be mapped to subcarriers contiguous to each other in the frequency domain. That is, the localized mapping scheme may be used within one subblock.

The transmitter 70 of FIG. 10 may be used both in a single carrier transmitter or a multi-carrier transmitter. If the transmitter 70 is used in the single carrier transmitter, all the N subblocks correspond to one carrier. If the transmitter 70 is used in the multi-carrier transmitter, each of the N subblocks may correspond to one carrier. Alternatively, even if the transmitter 70 is used in the multi-carrier transmitter, a plurality of subblocks of the N subblocks may correspond to one carrier. Meanwhile, in the transmitter 70 of FIG. 10, a time domain signal is generated through one IFFT unit 73. Accordingly, in order for the transmitter 70 of FIG. 10 to be used in a multi-carrier transmitter, subcarrier intervals between contiguous carriers in a contiguous carrier allocation situation must be aligned.

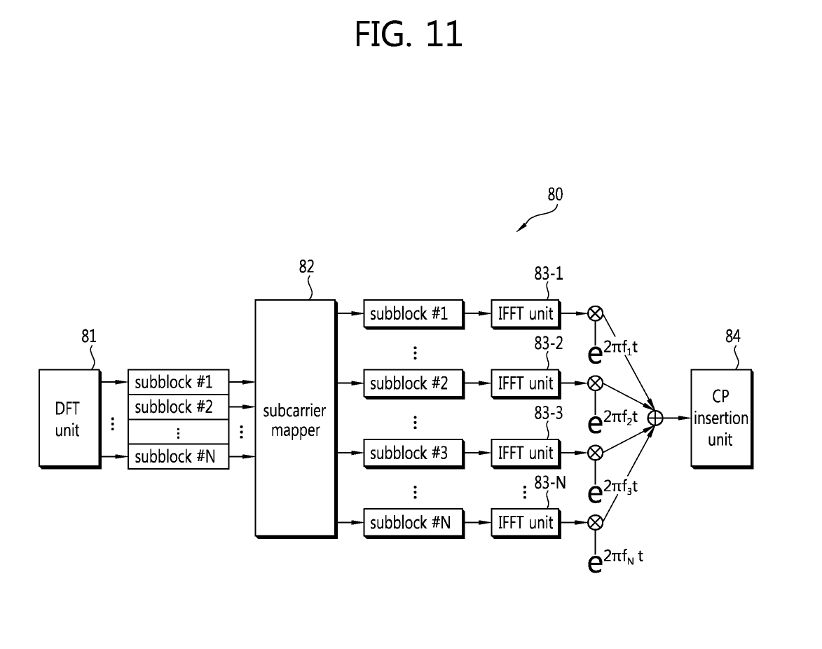

FIG. 11 shows another example of a transmitter using the clustered DFT-s OFDM transmission scheme. Referring to FIG. 11, the transmitter 80 includes a DFT unit 81, a subcarrier mapper 82, a plurality of IFFT units 83-1, 83-2, . . . , 83-N (N is a natural number), and a CP insertion unit 84. The transmitter 80 may further include a scramble unit (not shown), a modulation mapper (not shown), a layer mapper (not shown), and a layer permutator (not shown), which may be placed in front of the DFT unit 71.

IFFT is individually performed on each of N subblocks. An n^{th} IFFT unit 38-n outputs an n^{th} baseband signal (n=1, 2, . . . , N) by performing IFFT on a subblock #n. The n^{th} baseband signal is multiplied by an n^{th} carrier signal to produce an n^{th} radio signal. After the N radio signals generated from the N subblocks are added, a CP is inserted by the CP insertion unit 314. The transmitter 80 of FIG. 11 may be used in a discontiguous carrier allocation situation where carriers allocated to the transmitter are not contiguous to each other.

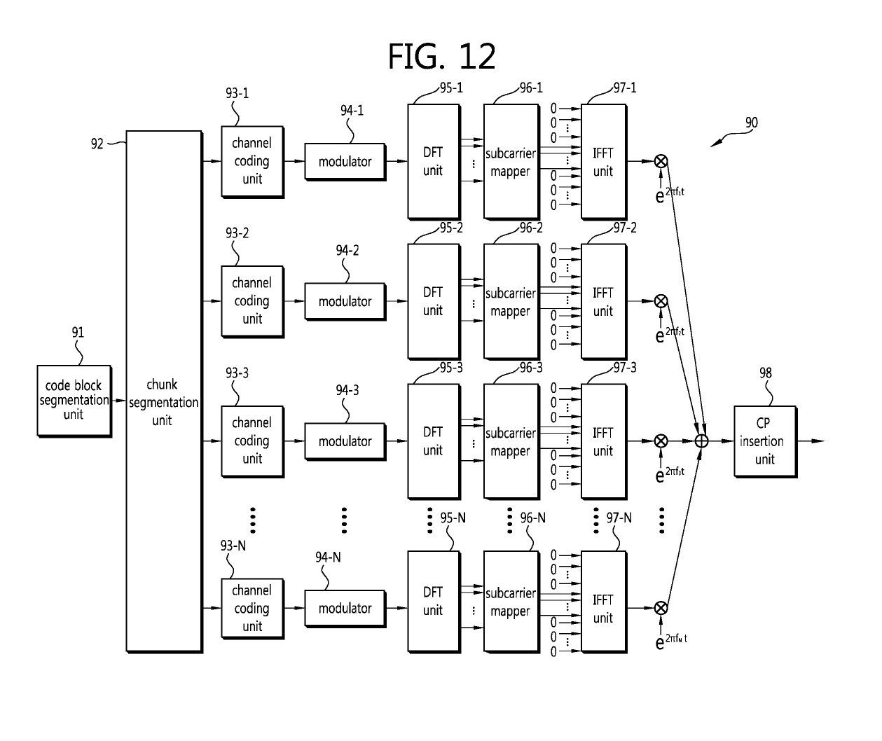

FIG. 12 is another example of a transmitter using the clustered DFT-s OFDM transmission scheme. FIG. 12 is a chunk-specific DFT-s OFDM system performing DFT precoding on a chunk basis. This may be called Nx SC-FDMA. Referring to FIG. 12, the transmitter 90 includes a code block division unit 91, a chunk division unit 92, a plurality of channel coding units 93-1, . . . , 93-N, a plurality of modulators 94-1, . . . , 4914-N, a plurality of DFT units 95-1, . . . , 95-N, a plurality of subcarrier mappers 96-1, . . . , 96-N, a plurality of IFFT units 97-1, . . . , 97-N, and a CP insertion unit 98. Here, N may be the number of multiple carriers used by a multi-carrier transmitter. Each of the channel coding units 93-1, . . . , 93-N may include a scramble unit (not shown). The modulators 94-1, . . . , 94-N may also be called modulation mappers. The transmitter 90 may further include a layer mapper (not shown) and a layer permutator (not shown) which may be placed in front of the DFT units 95-1, . . . , 95-N.

The code block division unit 91 divides a transmission block into a plurality of code blocks. The chunk division unit 92 divides the code blocks into a plurality of chunks. Here, the code block may be data transmitted by a multi-carrier transmitter, and the chunk may be a data piece transmitted through one of multiple carriers. The transmitter 90 performs DFT on a chunk basis. The transmitter 90 may be used in a discontiguous carrier allocation situation or a contiguous carrier allocation situation.

The following description is about resource allocation. A downlink resource or an uplink resource can be allocated for a PDSCH or a PUSCH. First, allocation of the downlink resource for the PDSCH will be described.

A UE interprets a resource allocation field included in a DCI format in a detected PDCCH. The resource allocation field in each PDCCH includes two parts, i.e., a resource allocation header field and information regarding actual resource allocation block assignment. Any one of type-0 resource allocation and type-1 resource allocation can be performed according to DCI formats 1, 2, 2A, and 2B. The type-0 resource allocation and the type-1 resource allocation can be distinguished from each other via a 1-bit resource allocation header field determined depending on a downlink system bandwidth. In this case, the type-0 resource allocation can be indicated if a value of the resource allocation header field is 0, and otherwise, the type-1 resource allocation can be indicated. Type-2 resource allocation can be performed according to DCI formats 1A, 1B, 1C, and 1D. If the type-2 resource allocation is performed, the DCI format does not include the resource allocation header field.

In the type-0 resource allocation, resource block assignment information includes a bitmap indicating a resource block group (RBG) allocated to a scheduled UE. The RBG is a set of consecutive virtual resource blocks (VRBs). RBG size (P) is a function of a system bandwidth as shown in Table 1 below.

TABLE 1

| System Bandwidth N_{RB}^{DL} | RBG Size (P) |
|---|---|
| ≦10 | 1 |
| 11-26 | 2 |
| 27-63 | 3 |
| 64-110 | 4 |

The total number of RBGs is given by N_{RBG}=┌N_{RB}^{DL}/P┐, where N_{RB}^{DL} is a downlink system bandwidth. Herein, └N_{RB}^{DL}/┘ RBGs are of size P, and if there are remaining RBs, the corresponding RBGs are of size N_{RB}^{DL}−P·└N_{RB}^{DL}/P┘. A bitmap including the resource block assignment information is of size N_{RBG}, and one bit is assigned for each RBG. The RBGs are indexed in the order of increasing frequency, and mapping between each RBG and the bitmap is achieved in such a manner that RBG 0 to RBG N_{RBG}−1 are mapped from most significant bit (MSB) to least significant bit (LSB), in that order. The RBG is allocated to the UE if its corresponding bit value is 1, and otherwise the RBG is not allocated to the UE.

In the type-1 resource allocation, resource block assignment information of size N_{RBG} indicates to the scheduled UE a VRB selected from a set of VRBs included in one RBG subset among P RBG subsets. P can be determined by Table 1. An RBG subset p (0≦p<P) includes every P^{th} RBG starting from an RBG p.

In the type-1 resource allocation, the resource block assignment information may include three fields. A first field is used to indicate one RBG subset selected from P RBG subsets. A second field is used to indicate a shift of a resource allocation span within the selected RBG subset. A third field includes a bitmap. Each bit of the bitmap indicates a single VRB in the selected RBG subset. In this case, mapping between the single VRB and the bitmap is achieved in such a manner that MSB to LSB, in that order, are mapped to the VRB in the increasing frequency order. A VRB is allocated to the UE if its corresponding bit value is 1, and otherwise the VRB is not allocated to the UE.

In the type-2 resource allocation, the resource block assignment information indicates to a scheduled UE a set of contiguously allocated localized VRBs or distributed VRBs. If the DCI format 1A, 1B, 1C, or 1D is used for resource allocation, a 1-bit flag can indicate whether localized VRBs or distributed VRBs are assigned. The localized VRBs can be assigned when a value of the flag is 0, and the distributed VRBs can be assigned when the value of the flag is 1. In addition, if the DCI format 1C is used for resource allocation, the distributed VRBs can be always assigned. The number of allocated localized VRBs varies from one to a maximum number of VRBs corresponding to a system bandwidth.

In the type-2 resource allocation, the resource allocation field of the DCI format 1C may include a resource indication value (RIV) determined from a start resource block RBₛₜₐᵣₜ and a length L_{CRBs} of virtually contiguously allocated resource blocks. The RIV can be determined by Equation 1 below.

$$if ( {L}_{CRBs} - 1 ) \leq ⌊ {N}_{RB}^{DL} / 2 ⌋ , \\ RIV = {N}_{RB}^{DL} ( {L}_{CRBs} - 1 ) + {RB}_{start} \\ else \\ RIV = {N}_{RB}^{DL} ( {N}_{RB}^{DL} - {L}_{CRBs} + 1 ) + ( {N}_{RB}^{DL} - 1 - {RB}_{start} ) \qquad 〈 Equation 1 〉$$

Herein, L_{CRBs}≧1, where L_{CBRs} does not exceed N_{VRB}^{DL}−RBₛₜₐᵣₜ.

Uplink resource allocation for the PUSCH is performed by using a method similar to downlink resource allocation for the PDSCH. The resource assignment information indicates to the scheduled UE a set of indices n_{VRB} of contiguously allocated VRBs. A resource allocation field in a scheduling grant may include an RIV determined from a start resource block RBₛₜₐᵣₜ and a length (L_{CRBs}≧1) of contiguously allocated resource blocks. The RIV can be determined by Equation 2 below.

$$if ( {L}_{CRBs} - 1 ) \leq ⌊ {N}_{RB}^{DL} / 2 ⌋ , \\ RIV = {N}_{RB}^{UL} ( {L}_{CRBs} - 1 ) + {RB}_{start} \\ else \\ RIV = {N}_{RB}^{UL} ( {N}_{RB}^{UL} - {L}_{CRBs} + 1 ) + ( {N}_{RB}^{UL} - 1 - {RB}_{start} ) \qquad 〈 Equation 2 〉$$

That is, the uplink resource allocation for the PUSCH can be performed by using the RIV similarly to the type-2 resource assignment among the downlink resource assignments for the PDSCH.

Meanwhile, in order to obtain a frequency diversity gain in LTE-A, distributed or non-contiguous uplink resource allocation can be performed for a PUSCH. That is, uplink resources can be allocated in a distributed manner by using the clustered DFT-OFDM transmission method described with reference to FIG. 10 to FIG. 12, and data can transmitted by using the allocated uplink resource. The LTE-A distributed uplink resource allocation needs to support dynamic switching with the conventional LTE rel-8/9 single uplink resource allocation. In the following description, the distributed uplink resource allocation or the non-contiguous uplink resource allocation are used for the same meaning.

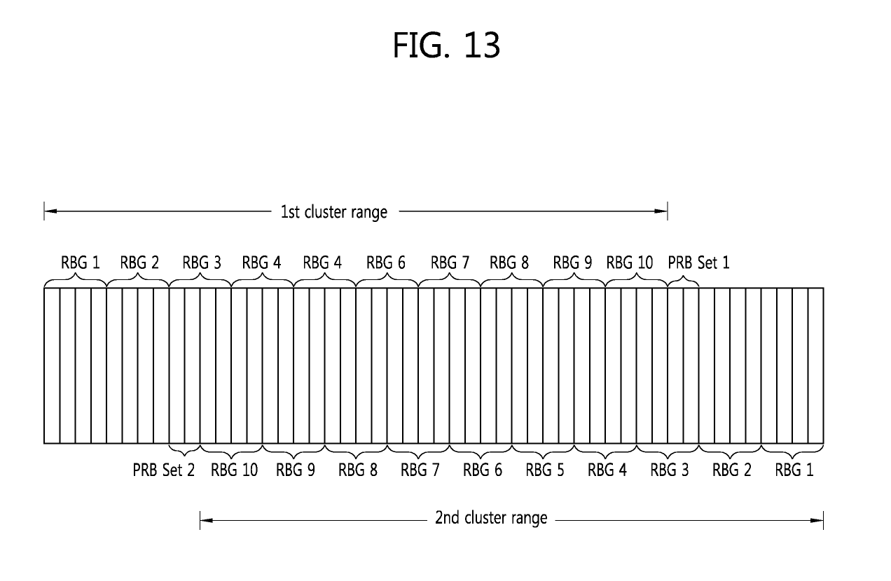

FIG. 13 shows an exemplary case of allocating distributed uplink resources.

In case of FIG. 13, two distributed clusters are allocated to uplink resources. Hereinafter, a cluster is defined as one aggregated part when the uplink resources are allocated in a distributed manner. In FIG. 13, N_{RB}^{UL}=50 when an uplink system bandwidth is 10 MHz. It is assumed that one RBG includes 4 RBs. A 1^{st} cluster can be selected as a part of an RBG 1 to an RBG 10 in that order. A 2^{nd} cluster can be selected as a part of the RBG 1 to the RBG 10 in the reverse order. The 1^{st} cluster and the 2^{nd} cluster do not overlap with each other.

Table 2 shows a size of a resource block assignment field in a DCI format depending on a system bandwidth in case of allocating two clusters.

TABLE 2

| System | Number of | |
|---|---|---|
| Bandwidth | RA Bits | RA Interpretation |
| 5 MHz | 10 | First 5 bits address 7 RBGs: |
| (RBG = 3) | | start from first, index in increasing order |
| | | Last 5 bits address 7 RBGs: |
| | | start from last, index in decreasing order |
| 10 MHz | 12 | First 6 bits address 10 RBGs: |
| (RBG = 4) | | start from first, index in increasing order |
| | | Last 6 bits address 10 RBGs: |
| | | start from last, index in decreasing order |
| 20 MHz | 14 | First 7 bits address 15 RBGs: |
| (RBG = 5) | | start from first, index in increasing order |
| | | Last 7 bits address 15 RBGs: |
| | | start from last, index in decreasing order |

Distributed uplink resources can be allocated by using various methods. When the uplink resources are allocated according to FIG. 13 and Table 2, there is an advantage in that the distributed uplink resources can be allocated by directly using the resource allocation method of LTE Rel-8/9 without having to introduce an additional resource allocation method. However, the resource allocation method cannot be supported if the number of clusters is greater than 2. Therefore, there is a need for a distributed resource allocation method for supporting a plurality of resources irrespective of the number of clusters or a size of the cluster.

Meanwhile, if a size of a DCI format for supporting the distributed uplink resource allocation is different from a size of the conventional DCI format, the size of the DCI format for supporting the distributed uplink resource allocation needs to be matched to a DL transmission mode configured semi-statically and using a greater-sized DCI format (DCI format 1 or 2) so that the number of blind decoding attempts is not increased from the perspective of a UE. However, for this, a system become more complex since any combination of an UL transmission mode and the semi-statically configured DL transmission mode needs to be defined to support the distributed uplink resource allocation. Therefore, the size of the DCI format for the distributed uplink resource allocation needs to be equal to the size of the conventional DCI format.

Bits for resource allocation can be allocated to each cluster when performing the distributed uplink resource allocation. In this case, the number of bits required for the resource allocation may be a value obtained by multiplexing the number of clusters by bits including position information of each cluster and bits including length information of each cluster. That is, a great number of bits are required for resource allocation when the uplink resources are allocated in a distributed manner by using a plurality of clusters. Meanwhile, it may be necessary to allocate the distributed uplink resources by using a format having the same size as the DCI format 0 which is an uplink DCI format of the conventional LTE rel-8/9. Therefore, an effective resource allocation method is required when allocating the distributed uplink resources.

Hereinafter, the proposed resource allocation method is described according to an embodiment of the present invention.

1) A case where a uniform spacing is maintained between respective clusters to which uplink resources are allocated will be first described. By maintaining the uniform spacing between the respective clusters, there is an advantage in that a peak-to-average power ratio (PAPR)/cubic metric (CM) is not significantly increased when allocating the uplink resources in a distributed manner or when using a clustered DFT-s OFDM transmission method.

The proposed resource allocation method first indicates the number of clusters. In this case, the number of clusters may be predetermined, or be radio resource control (RRC) signaled, or be dynamically allocated, or alternatively may be configured to have a fixed value according to a system bandwidth. The proposed resource allocation method additionally indicates a size of each cluster. The size of each cluster may also be predetermined, or be RRC signaled, or be dynamically allocated, or alternatively may be configured to have a fixed value according to a system bandwidth. Finally, the proposed resource allocation method can allocate resources to a system band while maintaining a uniform spacing between clusters by dividing the system bandwidth according to the number of clusters on the basis of the indicated number of clusters and by allocating one cluster, for each group, to uplink resources on the basis of the indicated number of clusters within one divided group. Alternatively, without being dependent on the number of clusters, the spacing between the respective clusters can be indicated, and a plurality of clusters can be allocated to uplink resources according to the indicated spacing. In this case, the spacing between the respective clusters may be predetermined, or be RRC signaled, or be dynamically allocated, or alternatively may be configured to have a fixed value according to a system bandwidth. Accordingly, when resource allocation is performed by determining one cluster as a reference cluster, a plurality of clusters can be allocated to uplink resources by indicating the number of clusters or a uniform spacing between the clusters on the basis of the reference cluster.

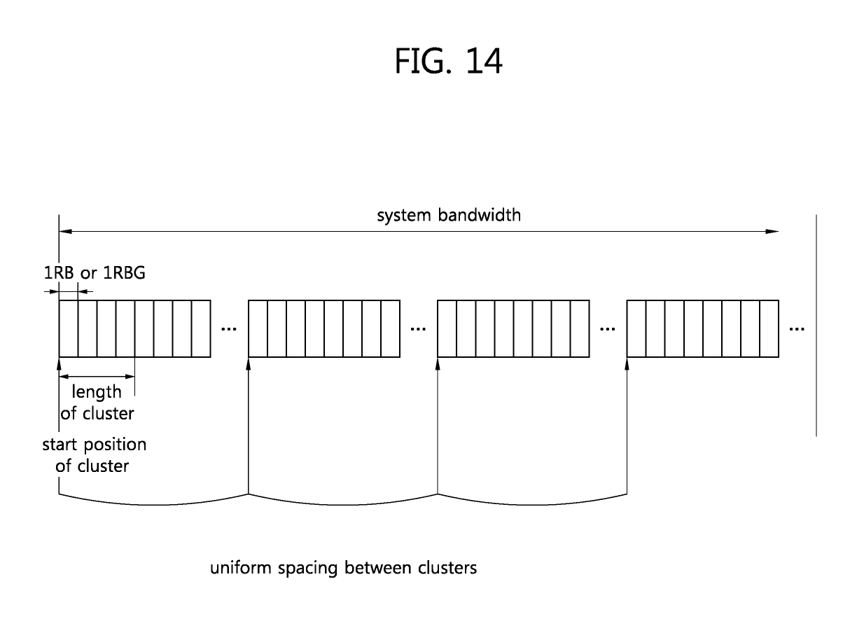

FIG. 14 shows an example of distributed uplink resource allocation according to the proposed resource allocation method.

In case of FIG. 14, a plurality of clusters is allocated in a system such that a uniform spacing is maintained between the respective clusters. The clusters may be allocated on a bandwidth in an RB granularity. Alternatively, the clusters may be allocated in an RBG granularity which is an aggregation of contiguous RBs. The number of RBs included in one RBG may be 2, 3, 4, 5, 10, or 20, or may be another integer. When the proposed method is used to allocate uplink resources, even if each cluster has a different length, a start position of each cluster has the same spacing in a frequency domain. Therefore, if any one of the plurality of clusters is determined as the reference cluster and a start position of the reference cluster is given, start positions of the remaining clusters can be known. If the respective clusters have different lengths, information regarding the lengths of the respective clusters may be indicated separately in an RB granularity or in an RBG granularity. The information regarding the lengths of the respective clusters may be RRC signaled or may be dynamically allocated.

If each cluster has the same length, the plurality of clusters can be allocated to uplink resources by indicating the number of clusters, the start position of the reference cluster, and the length of each cluster. Meanwhile, if each cluster has the same length, there is no need to indicate lengths of all clusters, and thus bits for uplink resource allocation may remain without being used. In this case, the remaining bits can be used to indicate information other than the length of the cluster. For example, if the cluster is allocated in an RBG granularity, a frequency allocation granularity can be decreased by decreasing an RBG size. Accordingly, frequency efficiency can be increased, and if more clusters are allocated, a frequency diversity gain can be further increased. That is, the bits for indicating the length of the cluster can be used for indicating start positions of more clusters generated when the frequency allocation granularity is decreased.

In case of using the resource allocation method of FIG. 14, distributed uplink resource allocation can be supported without any restriction in the number of clusters while maintaining a format having the same size as that of the DCI format 0 defined in LTE rel-8/9.

2) A method can be proposed for flexibly allocating clusters in respective resource groups while maintaining a uniform spacing between the resource groups to which respective clusters belong. By maintaining the uniform spacing between the resource groups to which the respective clusters belong, a PAPR/CM is not significantly increased when allocating uplink resources in a distributed manner or when using a clustered DFT-s OFDM transmission method, and flexibility of cluster allocation within each resource group can be increased.

The proposed resource allocation first indicates the number of clusters and a size of each cluster. In this case, the number of clusters and the size of each cluster may be predetermined, or be RRC signaled, or be dynamically allocated, or alternatively may be configured to have a fixed value according to a system bandwidth. In addition, the proposed resource allocation method indicates, for each group, start positions of clusters allocated to respective resource groups and a length of each cluster according to the number of designated clusters. If all of the clusters in the respective resource groups have the same length, the method may indicate only the start positions of the clusters in the respective resource groups, and regarding the length of the cluster, may indicate a length of one cluster. Accordingly, a signaling overhead can be decreased.

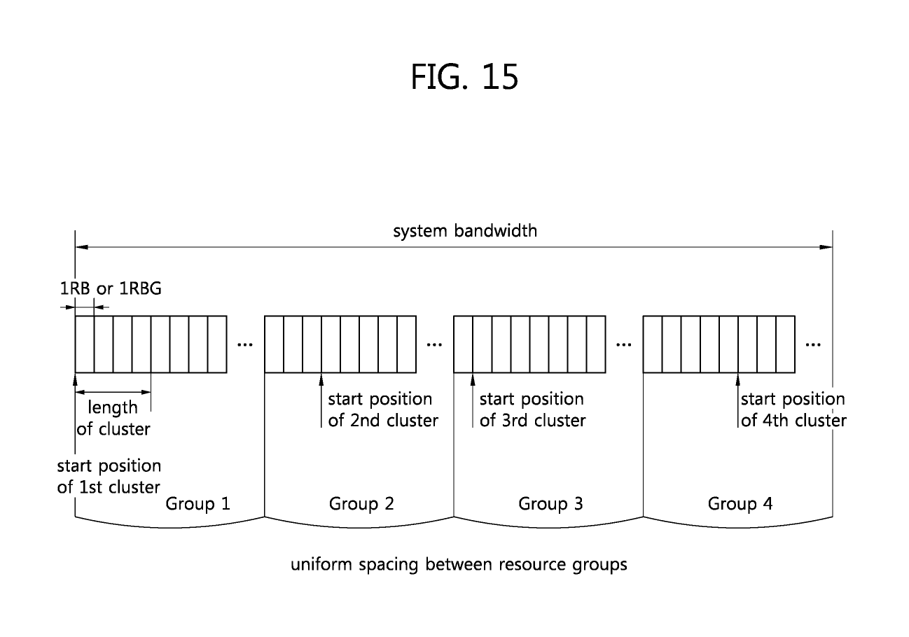

FIG. 15 shows another example of distributed uplink resource allocation according to the proposed resource allocation method.

Clusters may be allocated in an RB granularity on a bandwidth. Alternatively, the clusters may be allocated in an RBG granularity which is an aggregation of contiguous RBs. Referring to FIG. 15, a system bandwidth is divided into a plurality of resource groups. Each of the resource groups includes a cluster for distributed uplink resource allocation. Start positions of the respective resource groups are determined to have a uniform spacing. In the respective resource groups, the start positions of the clusters may differ from each other, and the respective clusters may have the same length or different lengths.

When using the resource allocation method of FIG. 15, distributed uplink resource allocation can be supported without any restriction in the number of clusters while maintaining a format having the same size as that of the DCI format 0 defined in LTE rel-8/9.

3) A method can be proposed for allocating a plurality of clusters in such a manner that a uniform spacing is maintained within a super group containing a plurality of resource groups and that a spacing of clusters differs between super groups. By maintaining the uniform spacing of clusters within the respective super groups, a PAPR/CM is not significantly increased when allocating uplink resources in a distributed manner or when using a clustered DFT-s OFDM transmission method and flexibility of cluster allocation within each super group can be increased.

The proposed resource allocation first indicates the number of clusters and a size of each cluster. In this case, the number of clusters and the size of each cluster may be predetermined, or be RRC signaled, or be dynamically allocated, or alternatively may be configured to have a fixed value according to a system bandwidth. In addition, the proposed resource allocation method indicates, for each super group, start positions of clusters allocated to respective super groups and a length of each cluster according to the number of designated clusters. In this case, a cluster allocated to one resource group within the super group can be determined as a reference cluster, and only a start position of the reference cluster can be indicated while the remaining clusters are allocated in the same spacing. If all of the clusters in the respective super groups have the same length, the method may indicate only the start positions of the clusters in the respective super groups, and regarding the length of the cluster, may indicate a length of one cluster. Accordingly, a signaling overhead can be decreased.

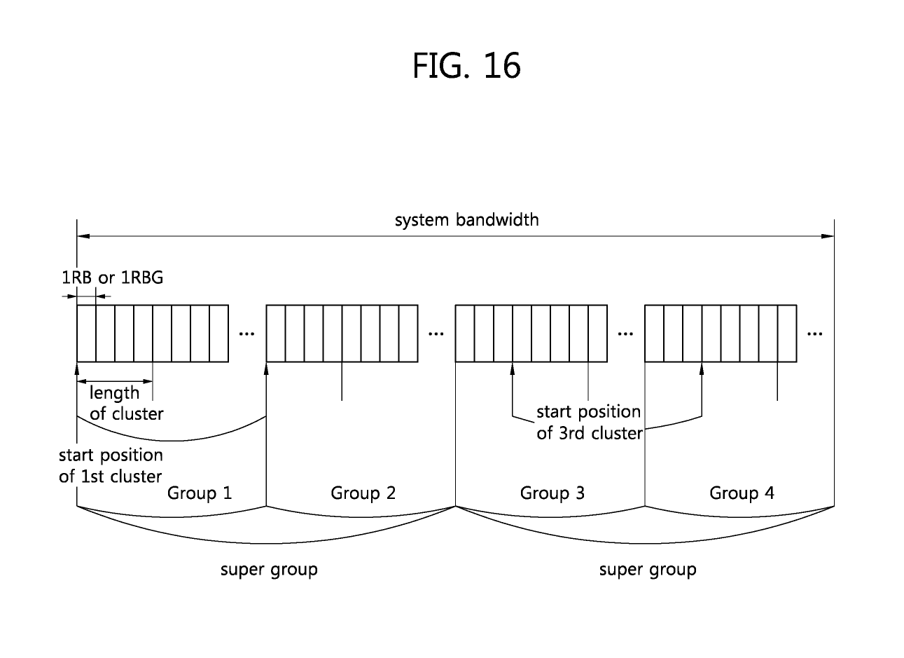

FIG. 16 to FIG. 18 shows another example of distributed uplink resource allocation according to the proposed resource allocation method.

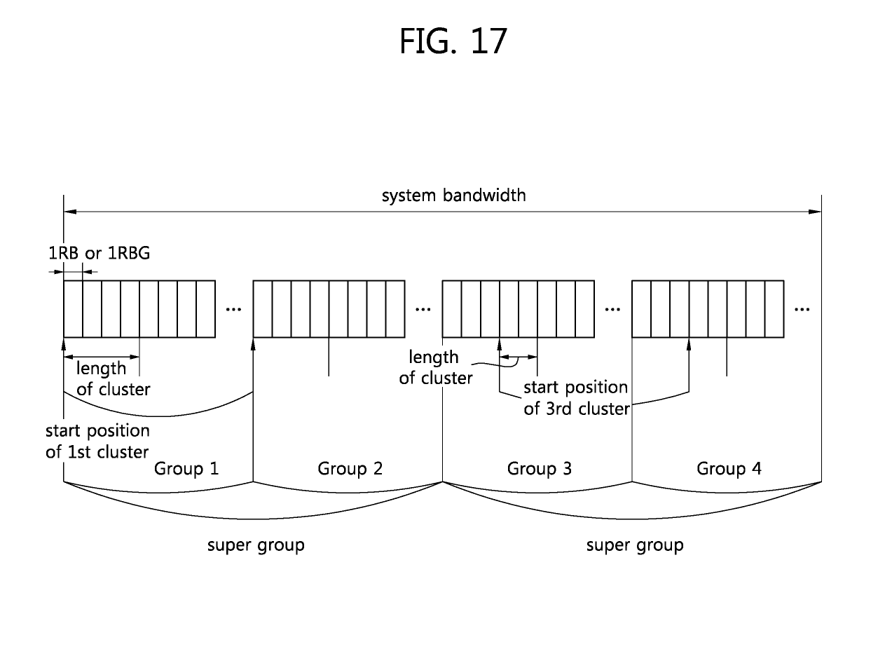

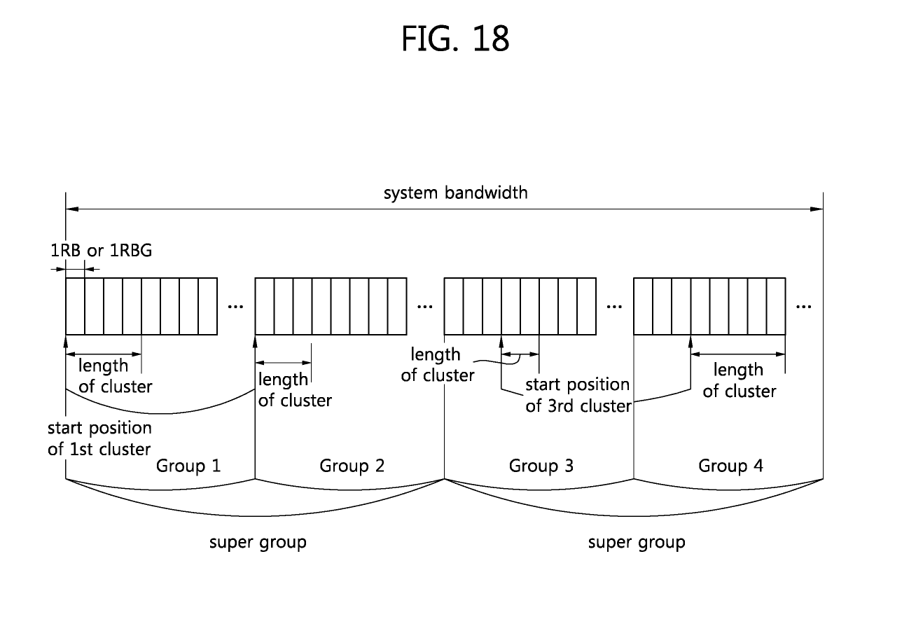

Clusters may be allocated in an RB granularity on a bandwidth. Alternatively, the clusters may be allocated in an RBG granularity which is an aggregation of contiguous RBs. Referring to FIG. 16 to FIG. 18, a system bandwidth is divided into a plurality of super groups. Each of the super groups includes a plurality of resource groups. Each of the resource groups includes a cluster for distributed uplink resource allocation. In case of FIG. 16, start positions of clusters allocated to a plurality of resource groups within a super group are different between super groups, and lengths of the clusters are identical irrespective of the super group. In case of FIG. 17, start positions and lengths of clusters allocated to a plurality of resource groups within a super group are different between super groups. That is, the start positions of the clusters are uniform within the super group, and the lengths of the clusters are uniform within the super group. In case of FIG. 18, only start positions of clusters allocated to a plurality of resource groups are uniform within the super group. That is, lengths of clusters may be different between super groups, and lengths of clusters allocated to resource groups may be different within a super group.

Meanwhile, in the aforementioned embodiment, a spacing between clusters or between a plurality of resource groups may be indicated in various manners. The spacing between clusters can be indicated on the basis of one reference cluster and a cluster allocated next to the reference cluster among a plurality of clusters. That is, the spacing between clusters can be indicated on the basis of a relative position between two clusters. Herein, if the number of clusters is 2, the reference cluster may be a 1^{st} cluster of which a start position is indicated. If the number of clusters is 3, the reference cluster may be fixed to the 1^{st} cluster of which the start position is indicated, or may be a cluster which is first allocated in terms of resource allocation. If the first allocated cluster is used as the reference cluster, the reference cluster may change whenever each cluster is allocated. For example, if three clusters are allocated, a 1^{st} cluster may be used as the reference cluster when a 2^{nd} cluster is allocated, and the 2^{nd} cluster may be used as the reference cluster when a 3^{rd} cluster is allocated.

First, the spacing between the clusters can be indicated on the basis of a start position of the reference cluster and a start position of a next cluster. Accordingly, the spacing between the clusters can be indicated, and start positions of the remaining clusters can be known on the basis of the spacing between the clusters and the start position of the reference cluster. In another method, the spacing between the clusters can be indicated on the basis of a last position of the reference cluster and a start position of a next cluster. The start position and the last position of the reference signal are indicated at the same time. Therefore, an additional indication is not necessary regarding an area occupied by the reference cluster, thereby decreasing a signaling overhead. In another method, the spacing between the clusters can be indicated on the basis of a last position of the reference cluster and a last position of a next cluster. The start position and the last position of the reference signal are indicated at the same time. Therefore, an additional indication is not necessary regarding an area occupied by the reference cluster, thereby decreasing a signaling overhead. In another method, the spacing between the clusters can be indicated on the basis of a start position of the reference cluster and a last position of a next cluster.

A length of each cluster can be additionally indicated if each cluster has a different length. A granularity for indicating a spacing between clusters can be determined according to the number of bits for indicating the spacing between clusters. The granularity for indicating the spacing between the clusters may be an RB, RBG, or cluster granularity. Alternatively, the spacing between the respective clusters may be predetermined, or be RRC signaled, or be dynamically allocated, or alternatively may be configured to have a fixed value according to a system bandwidth. In addition, the spacing of the clusters can be indicated independently for each cluster spacing according to the number of clusters. The aforementioned embodiment is applicable to all cases in which the number of clusters is 2 or higher.

As another method of allocating a plurality of clusters to distributed uplink resources, a method can be proposed in which a system bandwidth is divided according to the number of clusters, and each cluster is allocated in a uniform spacing within a corresponding group according to the number of clusters in one divided group.

Meanwhile, although an RB or RBG of each cluster allocated in a frequency domain is indexed in an increasing direction from the left to the right in the aforementioned embodiment, to the contrary, it may be indexed in an increasing direction from the right to the left. As such, a bit can be newly defined to determine an indexing direction of the RB or the RBG, thereby being able to indicate the indexing direction. For example, if a value of determining an indexing direction bit is 0, the RB or the RBG is indexed in an increasing direction from the left to the right, and if the value of determining the indexing direction bit is 1, the RB or the RBG can be indexed in an increasing direction from the right to the left.

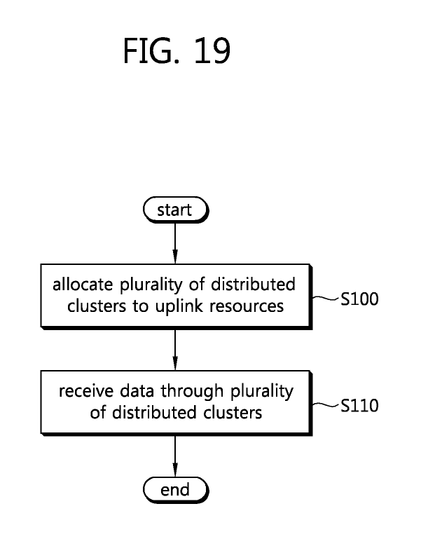

FIG. 19 shows the proposed resource allocation method according to an embodiment of the present invention.

In step S100, a BS transmits uplink resource allocation information to a UE and thus allocates a plurality of clusters distributed in a frequency domain to uplink resources. The plurality of distributed clusters can be allocated according to the method described above with reference to FIG. 14 to FIG. 18. The plurality of clusters can be allocated on the basis of at least one of a position of each cluster and a spacing between the plurality of clusters in the frequency domain. In step S110, the BS receives data through the plurality of distributed clusters.

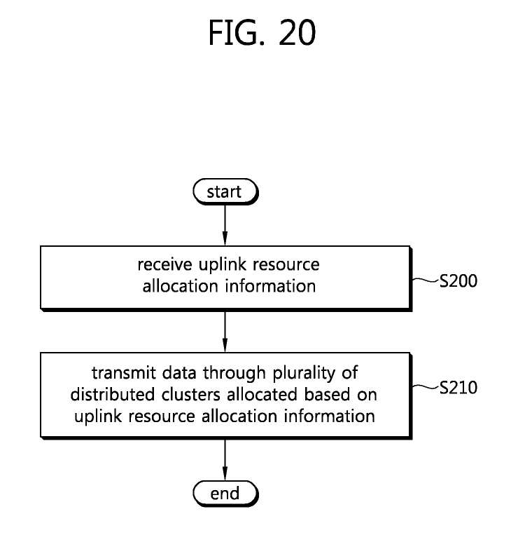

FIG. 20 shows the proposed data transmission method according to an embodiment of the present invention.

In step S200, a UE receives uplink resource allocation information from a BS. In step S110, the UE transmits data through a plurality of distributed clusters allocated on the basis of the uplink resource allocation information. The plurality of distributed clusters can be allocated by using the method described above with reference to FIG. 14 to FIG. 18.

Hereinafter, a method is described for allocating a plurality of distributed clusters by using an RIV defined in type-2 resource allocation of LTE Rel-8/9 when the plurality of distributed are allocated to uplink resources. Information on the plurality of clusters is required to allocate the plurality of clusters by using the RIV. In the method described hereinafter, the RIV is configured according to information on a start position of one reference cluster among the plurality of clusters, a length of a reference cluster, a spacing between the clusters, etc. If each cluster has a different length, the RIV can be configured by also including information on the length of each cluster. Although a method of allocating two distributed clusters by using a configured RIV is described hereinafter for convenience of explanation, the present invention is not limited thereto, and thus can be applied to a case in which three or more distributed clusters are allocated.

First, a case will be described in which, when two distributed clusters are allocated, the clusters have different lengths. An RIV can be configured on the basis of a length of a 1^{st} cluster with respect to a position of the 1^{st} cluster, a position of a 2^{nd} cluster depending on the length of the 1^{st} cluster, or a spacing from the 1^{st} cluster. For example, it is assumed that j denotes a start position of the 1^{st} cluster and i denotes a length of the 1^{st} cluster in a frequency domain in which clusters can be allocated by including N resources. The N resources are indexed from 0 to N−1, and j is a resource index on the frequency domain. A granularity of j, i, and N may be an RB granularity or an RBG granularity. In addition, j, i, and N may have different values depending on a system bandwidth. If it is assumed that the 1^{st} cluster and the 2^{nd} cluster have a minimum length, i.e., 1, and the 1^{st} cluster and the 2^{nd} cluster are allocated in a distributed manner with a spacing of at least one RB or RBG, then j is a value that varies from 0 to N−3. In addition, for the same reason, i is a value that varies from 1 to N−2−j. Accordingly, the number of states capable of indicating a start position of the 2^{nd} cluster and a length of the 2^{nd} cluster is (N−i−j−1)×(N−i−j)/2. (N−i−j−1)×(N−i−j)/2 states are 1:1 mapped to RIVs. First, each state depending on a change of i when j=0 can be mapped by increasing the RIV starting from 0, and in the same manner, each state can be mapped to the RIV by increasing j such as j=1, 2, etc. Alternatively, each state depending on a change of j when i=1 can be mapped by increasing the RIV starting from 0, and in the same manner, each state can be mapped to the RIV by increasing i such as i=2, 3, etc.

Now, a case will be described in which, when two distributed clusters are allocated, the clusters have the same length. An RIV can be configured on the basis of a position of a 2^{nd} cluster depending on a length of a 1^{st} cluster with respect to a position of the 1^{st} cluster or a spacing from the 1^{st} cluster. For example, it is assumed that j denotes a start position of the 1^{st} cluster and i denotes a length of the 1^{st} cluster in a frequency domain in which clusters can be allocated by including N resources. The N resources are indexed from 0 to N−1, and j is a resource index on the frequency domain. A granularity of j, i, and N may be an RB granularity or an RBG granularity. In addition, j, i, and N may have different values depending on a system bandwidth. If it is assumed that the 1^{st} cluster and the 2^{nd} cluster have a minimum length, i.e., 1, and the 1^{st} cluster and the 2^{nd} cluster are allocated in a distributed manner with a spacing of at least one RB or RBG, then j is a value that varies from 0 to N−3. In addition, for the same reason, i is a value that varies from 1 to ceil(N/2)−1−floor(j/2). ceil(N/2) is a minimum integer greater than N/2, and floor(j/2) is a maximum integer less than j/2. Accordingly, the number of states capable of indicating a start position of the 2^{nd} cluster and a length of the 2^{nd} cluster is (N−2×i−j). (N−2×i−j) states are 1:1 mapped to RIVs. First, each state depending on a change of i when j=0 can be mapped by increasing the RIV starting from 0, and in the same manner, each state can be mapped to the RIV by increasing j such as j=1, 2, . . . . Alternatively, each state depending on a change of j when i=1 can be mapped by increasing the RIV starting from 0, and in the same manner, each state can be mapped to the RIV by increasing such as i=2, 3, etc. First, each state depending on a change of i when j=0 can be mapped by increasing an RIV starting from 0, and in the same manner, each state can be mapped to the RIV by increasing such as j=1, 2, etc. Alternatively, each state depending on a change of j when i=1 can be mapped by increasing the RIV starting from 0, and in the same manner, each state can be mapped to the RIV by increasing i such as i=2, 3, etc.

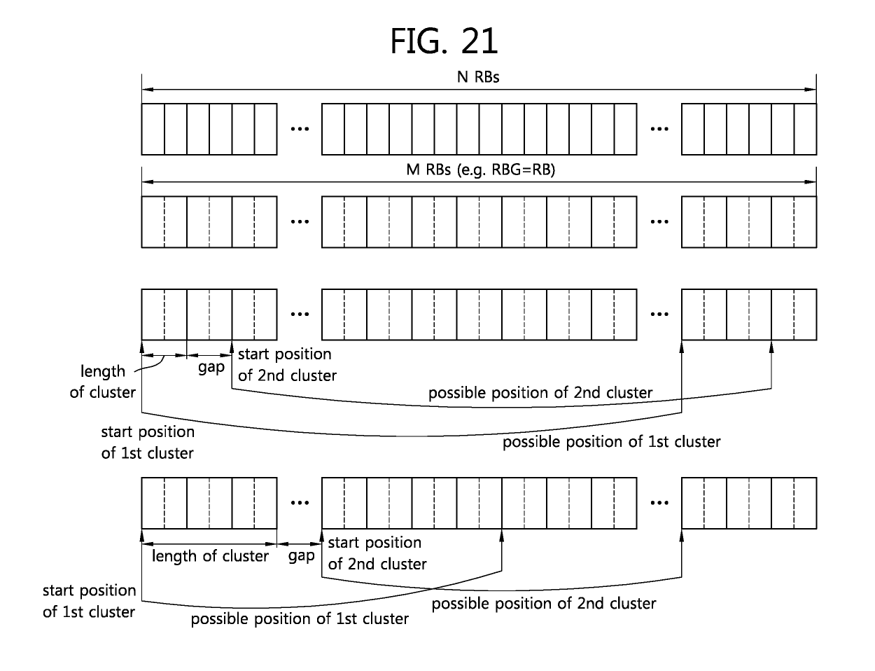

FIG. 21 shows a case in which, when two distributed clusters are allocated, the clusters have the same length.

Referring to FIG. 21, a system bandwidth includes N RBs or M RBGs. Although it is assumed in FIG. 21 that one RBG includes two RBs, the present invention is not limited thereto. In FIG. 21A, if a 1^{st} cluster and a 2^{nd} cluster are of length 1, the 1^{st} cluster can be allocated to any one RBG selected from a 1^{st} RBG to a 3^{rd}-to-last RBG, and the 2^{nd} cluster can be allocated to any one RBG selected from a 3^{rd} RBG to a last RBG. In FIG. 21B, if a 1^{st} cluster and a 2^{nd} cluster are of length 3, a start position of the 1^{st} cluster can be any one RBG selected from a 1^{st} RBG to a 7^{th}-to-last RBG, and a start position of the 2^{nd} cluster can be any one RBG selected from a 5^{th} RBG to a 3^{rd}-to-last RBG.

Meanwhile, although a case in which two distributed clusters have the same length is described for example in FIG. 21, the proposed resource allocation method is also applicable to a case in which two distributed clusters have different lengths. For example, a 1^{st} cluster may consist of 3 RBGs, and a 2^{nd} cluster may consist of 2 RBGs. Similarly to the embodiment of FIG. 21, a total system bandwidth can be divided by a granularity of multiple RBGs, and a start position and length of a reference cluster or 1^{st} cluster can be indicated. Further, a start position of the 2^{nd} cluster and a length of the 2^{nd} cluster can be indicated, or a spacing from the 1^{st} cluster and a length of the 2^{nd} cluster can be indicated.

The RIV configured by using the aforementioned method can be added to the conventional RIV configuration for resource allocation, or the RIV can be configured on the basis of only a spacing between clusters while a length of a corresponding cluster is indicated by using not the RIV but another method.

Table 3 shows a result of comparing the number of bits of a resource allocation field in the conventional DCI format with the number of bits of a resource allocation field in a DCI format according to the proposed resource allocation method when the number of clusters is 2. In Table 3, a case 1 is when two clusters have different lengths, and a case 2 is when the two clusters have the same length, that is, the case of FIG. 21. Referring to Table 3, the number of bits of the resource allocation field of the DCI format according to the proposed resource allocation method is less than or equal to the number of bits of the resource allocation field of the conventional DCI format. In addition, since a resource allocation granularity is decreased by the proposed resource allocation method, there is an advantage in that a frequency diversity gain can be obtained while decreasing a signaling overhead. Meanwhile, it is assumed that all of the proposed resource allocation methods can adjust sizes of all DCI formats to a DCI format 0. In addition, in the DCI format 0, for distributed uplink resource allocation, an additional one bit can be used to indicate the distributed uplink resource allocation. When the distributed uplink resource is allocated, frequency hopping is not used between subframes or within a subframe, and thus a frequency hopping field of the DCI format 0 can be used as an additional bit for resource allocation. In addition, a padding bit can also be used as the additional bit for resource allocation.

TABLE 3

| | | | | | Total # of |
|---|---|---|---|---|---|
| | | | | Total # of | bits for re- |
| | | | | bits for | source allo- |
| | | | RBG | distributed | cation field |
| | | Total # | granu- | resource | of DCI format |
| | Bandwidth | of RB | larity | allocation | 0 in Rel-8 |
| case 1 | 20 MHz | 100 | 4 | 14 | 13 |
| case 2 | | | 2 | 14 | |
| convention | | | 5 | 14 | |
| case 1 | 15 MHz | 75 | 4 | 13 | 12 |
| case 2 | | | 2 | 13 | |
| convention | | | N/A | N/A | |
| case 1 | 10 MHz | 50 | 3 | 12 | 11 |
| case 2 | | | 2 | 11 | |
| convention | | | 4 | 12 | |
| case 1 | 5 MHz | 25 | 2 | 10 | 9 |
| case 2 | | | 2 | 8 | |
| convention | | | 3 | 10 | |
| case 1 | 3 MHz | 15 | 2 | 7 | 7 |
| case 2 | | | 1 | 8 | |
| convention | | | N/A | N/A | |
| case 1 | 1.4 MHz | 6 | 1 | 5 | 5 |
| case 2 | | | 1 | 4 | |
| convention | | | N/A | N/A | |

Hereinafter, an RIV configuration will be described by using equations.

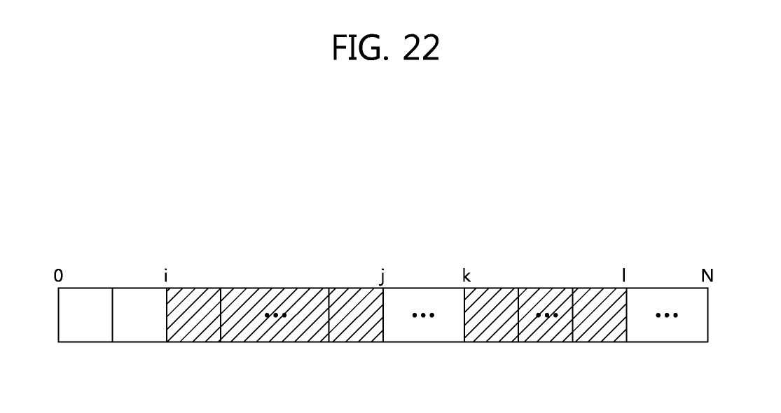

FIG. 22 shows a frequency domain in which two clusters are allocated.

Referring to FIG. 22, the frequency domain includes N resources. A 1^{st} cluster is allocated from an index i to an index j, and a 2^{nd} cluster is allocated from an index k to an index f.

On the basis of the frequency domain of FIG. 22, an RIV can be defined by Equation 3.

$$- {RIV}_{1} ( i ) = i , ( 0 \leq i \leq j - 1 ) \\ - {RIV}_{2} ( j , k , l ) = {RIV}_{rel - 8} ( L 2 , S 2 , N 2 ) , \\ where S 2 = k - j - 1 , L 2 = l - k , and N 2 = N - j - 1 \\ - {Max}_{{RIV}_{1}} ( j ) = j \\ - {Max}_{{RIV}_{2}} ( j ) = \frac{( N - j - 1 ) ( N - j )}{2} \\ - {Max}_{RIV} ( j ) = {Max}_{{RIV}_{1}} ( j ) \times {Max}_{{RIV}_{2}} ( j ) \qquad 〈 Equation 3 〉$$

In Equation 3, the 1^{st} cluster can be encoded to a start position of the 1^{st} cluster when a last position is j=S1+L1−1. The 2^{nd} cluster can directly use the Rel-8 RIV encoding method when the last position of the 1^{st} cluster is j=S1+L1−1 and N2=N_{RBG}−S1−L1−1 according to the number N2 of RBGs included in the 2^{nd} cluster. Max_{RIV1}(j) and Max_{RIV2}(j) are the total numbers of states for indicating the 2^{nd} cluster when the last position of the 1^{st} cluster is j=S1+L1−1.

An encoded index for I, J, K, and L in Equation 3 can be expressed by Equation 4 below.

$$\begin{matrix}RIV ( I , J , K , L ) = {\sum }_{j = 0}^{J - 1} {Max}_{RIV} ( j ) + {Max}_{{RIV}_{1}} ( J ) \times \\ {RIV}_{2} ( J , K , L ) + {RIV}_{1} ( I ) \\ = {\sum }_{j = 0}^{J - 1} ( j \cdot \frac{( N - j - 1 ) ( N - j )}{2} ) + \\ J \cdot {RIV}_{2} ( J , K , L ) + I\end{matrix} \qquad 〈 Equation 4 〉$$

In Equation 4, last positions J and L of the respective clusters can be replaced with start positions I and K of the respective clusters and lengths L1 and L2 of the respective clusters, as shown in Equation 5.

$$RIV ( I , I + L 1 , K , K + L 2 ) = {\sum }_{j = 0}^{I + L 1 - 1} {Max}_{RIV} ( j ) + {Max}_{{RIV}_{1}} ( I + L 1 ) \times {RIV}_{2} ( I + L 1 , K , K + L 2 ) + {RIV}_{1} ( I ) = {\sum }_{j = 0}^{I + L 1 - 1} ( j \cdot \frac{( N - j - 1 ) ( N - j )}{2} ) + ( I + L 1 ) \cdot {RIV}_{2} ( I + L 1 , K , K + L 2 ) + I \qquad 〈 Equation 5 〉$$

Alternatively, when using a gap G between two clusters, since G=K−J, if J=K−G is substituted to G, it can be expressed by Equation 6 below.

$$RIV ( I , K - G , K , L ) = {\sum }_{j = 0}^{K - G - 1} {Max}_{RIV} ( j ) + {Max}_{{RIV}_{1}} ( K - G ) \times {RIV}_{2} ( K - G , K , L ) + {RIV}_{1} ( I ) = {\sum }_{j = 0}^{K - G - 1} ( j \cdot \frac{( N - j - 1 ) ( N - j )}{2} ) + ( K - G ) \cdot {RIV}_{2} ( K - G , K , L ) + I \qquad 〈 Equation 6 〉$$

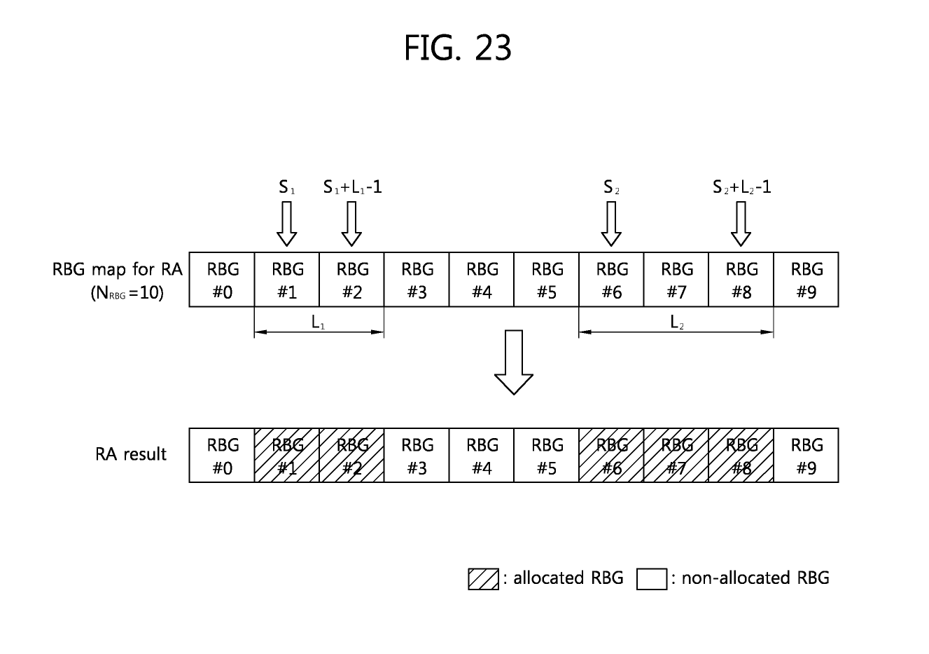

FIG. 23 shows a frequency domain in which two clusters are allocated. A 1^{st} cluster is allocated contiguously to RBG #1, #2. A 2^{nd} cluster is allocated contiguously to RBG #6, #7, #8. In the frequency domain of FIG. 23, an RIV can be defined by Equation 3 to Equation 6. Equation 3 and Equation 4 can be replaced with Equation 7 and Equation 8 by using S1, L1, S2, and L2 of FIG. 23.

$$\begin{matrix}{RIV}_{1} ( {S}_{1} ) = {S}_{1} \\ {RIV}_{2} ( {N}_{2} , {S}_{2} , {L}_{2} ) = {RIV}_{Rel - 8} ( {N}_{2} , {S}_{2} , {L}_{2} ) \\ {Max}_{RIV 1} ( {S}_{1} + {L}_{1} - 1 ) = {S}_{1} + {L}_{1} \\ {Max}_{RIV 2} ( {S}_{1} + {L}_{1} - 1 ) = \frac{{N}_{2} ( {N}_{2} + 1 )}{2} \\ {Max}_{RIV} ( {S}_{1} + {L}_{1} - 1 ) = {Max}_{RIV 1} ( {S}_{1} + {L}_{1} - 1 ) \cdot {Max}_{RIV 2} ( {S}_{1} + {L}_{1} - 1 ) & 〈 Equation 7 〉 \\ RIV ( {S}_{1} , {L}_{1} , {S}_{2} , {L}_{2} ) = {\sum }_{j = 0}^{{S}_{1} + {L}_{1} - 2} {Max}_{RIV} ( j ) + {Max}_{RIV 1} ( {S}_{1} + {L}_{1} - 1 ) \cdot {RIV}_{2} ( {N}_{2} , {S}_{2} , {L}_{2} ) + {RIV}_{1} ( {S}_{1} ) & 〈 Equation 8 〉\end{matrix}$$

In Equation 7, the 1^{st} cluster can be encoded to the start position of the 1^{st} cluster when the last position is S1+L1−1. The 2^{nd} cluster can directly use the Rel-8 RIV encoding method when the last position of the 1^{st} cluster is S1+L1−1 and N2=N_{RBG}−S1−L1−1 according to the number N2 of RBGs included in the 2^{nd} cluster. Max_{RIV1}(j) and Max_{RIV2}(j) are the total numbers of states for indicating the 2^{nd} cluster when the last position of the 1^{st} cluster is j=S1+L1−1.

Various methods for expressing the RIV on the basis of Equation 3 to Equation 8 will be described.

Equation 9 is an exemplary equation for expressing the RIV.

$$RIV = {\sum }_{j = 0}^{{S}_{1} + {L}_{1} - 1} j \frac{( N - j - 1 ) ( N - j )}{2} + ( {S}_{1} + {L}_{1} ) \cdot {RIV}_{2 nd\_cluster} + {S}_{1} \qquad 〈 Equation 9 〉$$

In Equation 9, RIV2nd_cluster can be expressed by Equation 10 below.

$$\begin{matrix}{RIV}_{2 nd\_cluster} = {RIV}_{Rel - 8} ( {N}_{1} , {\tilde{S}}_{2} , {L}_{2} ) \\ = \{ \begin{matrix}{N}_{1} ( {L}_{2} - 1 ) + {\tilde{S}}_{2} , & {L}_{2} - 1 \leq ⌊ \frac{{N}_{1}}{2} ⌋ \\ {N}_{1} ( {N}_{1} - {L}_{2} + 1 ) + ( {N}_{1} - 1 - {\tilde{S}}_{2} ) , & else ,\end{matrix}\end{matrix} \\ where {N}_{1} = N - ( {S}_{1} + {L}_{1} + 1 ) , {\tilde{S}}_{2} = {S}_{2} - ( {S}_{1} + {L}_{1} + 1 ) \\ or \\ \begin{matrix}{RIV}_{2 nd\_cluster} = {RIV}_{Rel - 8} ( {N}_{1} , {\tilde{S}}_{2} , {L}_{2} ) \\ = {RIV}_{Rel - 8} ( N - ( {S}_{1} + {L}_{1} + 1 ) , {S}_{2} - ( {S}_{1} + {L}_{1} + 1 ) , {L}_{2} ) \\ = \{ \begin{matrix}\{ N - ( {S}_{1} + {L}_{1} + 1 ) \} ( {L}_{2} - 1 ) + {S}_{2} - ( {S}_{1} + {L}_{1} + 1 ) , & {L}_{2} - 1 \leq ⌊ \frac{N - ( {S}_{1} + {L}_{1} + 1 )}{2} ⌋ \\ \begin{matrix}\{ N - ( {S}_{1} + {L}_{1} + 1 ) \} \{ N - ( {S}_{1} + {L}_{1} + 1 ) - {L}_{2} + 1 \} + \\ \{ N - ( {S}_{1} + {L}_{1} + 1 ) - 1 - {S}_{2} + ( {S}_{1} + {L}_{1} + 1 ) \} ,\end{matrix} & else\end{matrix}\end{matrix} \qquad 〈 Equation 10 〉$$

Equation 11 is another exemplary equation for expressing the RIV.

$$RIV = {RIV}_{1 st\_cluster} ( {S}_{1} , {L}_{1} ) + {RIV}_{2 nd\_cluster} ( {S}_{1} , {L}_{1} , {S}_{2} , {L}_{2} ) - 1 \\ RIV ( {S}_{1} , {L}_{1} , {S}_{2} , {L}_{2} ) = \underbrace{{\sum }_{i = 0}^{{S}_{1} - 1} F ( i ) + {\sum }_{j = 1}^{{L}_{1} - 1} \frac{( N - {S}_{1} - j - 1 ) ( N - {S}_{1} - j )}{2}}_{{RIV}_{1 st\_cluster} ( {S}_{1} , {L}_{1} )} + {RIV}_{2 nd\_cluster} ( {S}_{1} , {L}_{1} , {S}_{2} , {L}_{2} ) - 1 \\ F ( i ) = {\sum }_{j = 1}^{N - 2 - i} \frac{( N - i - j - 1 ) ( N - i - j )}{2} \qquad 〈 Equation 11 〉$$

In Equation 11, RIV2nd_cluster can be expressed by Equation 12 below.

$${RIV}_{2 nd\_cluster} ( {S}_{1} , {L}_{1} , {S}_{2} , {L}_{2} ) = \{ \begin{matrix}\{ N - ( {S}_{1} + {L}_{1} + 1 ) \} ( {L}_{2} - 1 ) + {S}_{2} , & {L}_{2} - 1 \leq ⌊ \frac{N - ( {S}_{1} + {L}_{1} + 1 )}{2} ⌋ \\ \begin{matrix}\{ N - ( {S}_{1} + {L}_{1} + 1 ) \} \{ N - ( {S}_{1} + {L}_{1} + 1 ) - {L}_{2} + 1 \} + \\ \{ N - ( {S}_{1} + {L}_{1} + 1 ) - 1 - {S}_{2} \} ,\end{matrix} & else\end{matrix} \qquad 〈 Equation 12 〉$$

In Equation 12, S can be expressed with a gap G between two clusters. That is, since G=S2−(S1+L1), it can be replaced with S2=G+(S1+L1).

Equation 13 is another exemplary equation for expressing the RIV.

$$RIV = {RIV}_{1 st\_cluster} ( {S}_{1} , {L}_{1} ) + {RIV}_{2 nd\_cluster} ( {S}_{1} , {L}_{1} , {S}_{2} , {L}_{2} ) \\ RIV ( {S}_{1} , {L}_{1} , {S}_{2} , {L}_{2} ) = \underbrace{{\sum }_{i = 0}^{{S}_{1} - 1} F ( i ) + {\sum }_{j = 1}^{{L}_{1} - 1} \frac{( N - {S}_{1} - j - 1 ) ( N - {S}_{1} - j )}{2}}_{{RIV}_{1 st\_cluster} ( {S}_{1} , {L}_{1} )} + {RIV}_{2 nd\_cluster} ( {S}_{1} , {L}_{1} , {S}_{2} , {L}_{2} ) \\ F ( i ) = {\sum }_{j = 1}^{N - 2 - i} \frac{( N - i - j - 1 ) ( N - i - j )}{2} \qquad 〈 Equation 13 〉$$

In Equation 13, RIV2nd_cluster can be expressed by Equation 14 below.

$${RIV}_{2 nd\_cluster} ( {S}_{1} , {L}_{1} , {S}_{2} , {L}_{2} ) = \{ \begin{matrix}\{ N - ( {S}_{1} + {L}_{1} + 1 ) \} ( {L}_{2} - 1 ) + {S}_{2} - ( {S}_{1} + {L}_{1} + 1 ) , & {L}_{2} - 1 \leq ⌊ \frac{N - ( {S}_{1} + {L}_{1} + 1 )}{2} ⌋ \\ \begin{matrix}\{ N - ( {S}_{1} + {L}_{1} + 1 ) \} \{ N - ( {S}_{1} + {L}_{1} + 1 ) - {L}_{2} + 1 \} + \\ \{ N - ( {S}_{1} + {L}_{1} + 1 ) - 1 - {S}_{2} + ( {S}_{1} + {L}_{1} + 1 ) \} ,\end{matrix} & else\end{matrix} \qquad 〈 Equation 12 〉$$

In Equation 13 and Equation 14, S2 can be expressed with a gap G between two clusters. That is, since G=S2−(S1+L1), it can be replaced with S2=G+(S1+L1).

By using G, Equation 13 and Equation 14 can be replaced with Equation 15 and Equation 16.

$$\begin{matrix}RIV = {RIV}_{1 st\_cluster} ( {S}_{1} , {L}_{1} ) + {RIV}_{2 nd\_cluster} ( {S}_{1} , {L}_{1} , G , {L}_{2} ) \\ RIV ( {S}_{1} , {L}_{1} , G , {L}_{2} ) = \underbrace{{\sum }_{i = 0}^{{S}_{1} - 1} F ( i ) + {\sum }_{j = 1}^{{L}_{1} - 1} \frac{( N - {S}_{1} - j - 1 ) ( N - {S}_{1} - j )}{2}}_{{RIV}_{1 st\_cluster} ( {S}_{1} , {L}_{1} )} + {RIV}_{2 nd\_cluster} ( {S}_{1} , {L}_{1} , G , {L}_{2} ) \\ F ( i ) = {\sum }_{j = 1}^{N - 2 - i} \frac{( N - i - j - 1 ) ( N - i - j )}{2} & 〈 Equation 15 〉 \\ {RIV}_{2 nd\_cluster} ( {S}_{1} , {L}_{1} , {S}_{2} , {L}_{2} ) = \{ \begin{matrix}\{ N - ( {S}_{1} + {L}_{1} + 1 ) \} ( {L}_{2} - 1 ) + G - 1 & {L}_{2} - 1 \leq ⌊ \frac{N - ( {S}_{1} + {L}_{1} + 1 )}{2} ⌋ \\ \begin{matrix}\{ N - ( {S}_{1} + {L}_{1} + 1 ) \} \{ N - ( {S}_{1} + {L}_{1} + 1 ) - {L}_{2} + 1 \} + \\ \{ N - ( {S}_{1} + {L}_{1} + 1 ) - 1 - G + 1 \} ,\end{matrix} & else\end{matrix} & 〈 Equation 16 〉\end{matrix}$$

Equation 17 is another exemplary equation for expressing the RIV.

$$RIV = {RIV}_{1 st\_cluster} ( {S}_{1} , {L}_{1} ) + {RIV}_{2 nd\_cluster} ( {S}_{1} , {L}_{1} , {S}_{2} , {L}_{2} ) \\ RIV ( {S}_{1} , {L}_{1} , {S}_{2} , {L}_{2} ) = \underbrace{{\sum }_{i = 0}^{{S}_{1} - 1} F ( i ) + {\sum }_{j = 1}^{{L}_{1} - 1} \frac{( N - {S}_{1} - j - 1 ) ( N - {S}_{1} - j )}{2}}_{{RIV}_{1 st\_cluster} ( {S}_{1} , {L}_{1} )} + {RIV}_{2 nd\_cluster} ( {S}_{1} , {L}_{1} , {S}_{2} , {L}_{2} ) - 1 \\ F ( i ) = {\sum }_{j = 1}^{N - 2 - i} \frac{( N - i - j - 1 ) ( N - i - j )}{2} \qquad 〈 Equation 17 〉$$

In Equation 17, RIV2nd_cluster can be expressed by Equation 18 below.

$$\begin{matrix}{RIV}_{2 nd\_cluster} = {RIV}_{Rel - 8} ( {N}_{1} , {\tilde{S}}_{2} , {L}_{2} ) \\ = \{ \begin{matrix}{N}_{1} ( {L}_{2} - 1 ) + {\tilde{S}}_{2} , & {L}_{2} - 1 \leq ⌊ \frac{{N}_{1}}{2} ⌋ \\ {N}_{1} ( {N}_{1} - {L}_{2} + 1 ) + ( {N}_{1} - 1 - {\tilde{S}}_{2} ) , & else ,\end{matrix}\end{matrix} \\ where {N}_{1} = N - ( {S}_{1} + {L}_{1} + 1 ) , {\tilde{S}}_{2} = {S}_{2} - ( {S}_{1} + {L}_{1} + 1 ) \\ or \\ \begin{matrix}{RIV}_{2 nd\_cluster} = {RIV}_{Rel - 8} ( {N}_{1} , {\tilde{S}}_{2} , {L}_{2} ) \\ = {RIV}_{Rel - 8} ( N - ( {S}_{1} + {L}_{1} + 1 ) , {S}_{2} - ( {S}_{1} + {L}_{1} + 1 ) , {L}_{2} ) \\ = \{ \begin{matrix}\{ N - ( {S}_{1} + {L}_{1} + 1 ) \} ( {L}_{2} - 1 ) + {S}_{2} - ( {S}_{1} + {L}_{1} + 1 ) , & {L}_{2} - 1 \leq ⌊ \frac{N - ( {S}_{1} + {L}_{1} + 1 )}{2} ⌋ \\ \begin{matrix}\{ N - ( {S}_{1} + {L}_{1} + 1 ) \} \{ N - ( {S}_{1} + {L}_{1} + 1 ) - {L}_{2} + 1 \} + \\ \{ N - ( {S}_{1} + {L}_{1} + 1 ) - 1 - {S}_{2} + ( {S}_{1} + {L}_{1} + 1 ) \} ,\end{matrix} & else\end{matrix}\end{matrix} \qquad 〈 Equation 18 〉$$

In Equation 17 and Equation 18, S2 can be expressed with a gap G between two clusters. That is, since G=S2−(S1+L1), it can be replaced with S2=G+(S1+L1).

By using G, Equation 17 and Equation 18 can be replaced with Equation 19 and Equation 20.

$$\begin{matrix}RIV = {RIV}_{1 st\_cluster} ( {S}_{1} , {L}_{1} ) + {RIV}_{2 nd\_cluster} ( {S}_{1} , {L}_{1} , G , {L}_{2} ) \\ RIV ( {S}_{1} , {L}_{1} , G , {L}_{2} ) = \underbrace{{\sum }_{i = 0}^{{S}_{1} - 1} F ( i ) + {\sum }_{j = 1}^{{L}_{1} - 1} \frac{( N - {S}_{1} - j - 1 ) ( N - {S}_{1} - j )}{2}}_{{RIV}_{1 st\_cluster} ( {S}_{1} , {L}_{1} )} + {RIV}_{2 nd\_cluster} ( {S}_{1} , {L}_{1} , G , {L}_{2} ) \\ F ( i ) = {\sum }_{j = 1}^{N - 2 - i} \frac{( N - i - j - 1 ) ( N - i - j )}{2} & 〈 Equation 19 〉 \\ \begin{matrix}{RIV}_{2 nd\_cluster} = {RIV}_{Rel - 8} ( {N}_{1} , {\tilde{S}}_{2} , {L}_{2} ) \\ = \{ \begin{matrix}{N}_{1} ( {L}_{2} - 1 ) + {\tilde{S}}_{2} , & {L}_{2} - 1 \leq ⌊ \frac{{N}_{1}}{2} ⌋ \\ {N}_{1} ( {N}_{1} - {L}_{2} + 1 ) + ( {N}_{1} - 1 - {\tilde{S}}_{2} ) , & else ,\end{matrix}\end{matrix} \\ where {N}_{1} = N - ( {S}_{1} + {L}_{1} + 1 ) , {\tilde{S}}_{2} = G - 1 \\ or \\ \begin{matrix}{RIV}_{2 nd\_cluster} = {RIV}_{Rel - 8} ( {N}_{1} , G - 1 , {L}_{2} ) \\ = {RIV}_{Rel - 8} ( N - ( {S}_{1} + {L}_{1} + 1 ) , G - 1 , {L}_{2} ) \\ = \{ \begin{matrix}\{ N - ( {S}_{1} + {L}_{1} + 1 ) \} ( {L}_{2} - 1 ) + G - 1 , & {L}_{2} - 1 \leq ⌊ \frac{N - ( {S}_{1} + {L}_{1} + 1 )}{2} ⌋ \\ \begin{matrix}\{ N - ( {S}_{1} + {L}_{1} + 1 ) \} \{ N - ( {S}_{1} + {L}_{1} + 1 ) - {L}_{2} + 1 \} + \\ \{ N - ( {S}_{1} + {L}_{1} + 1 ) - 1 - G + 1 \} ,\end{matrix} & else\end{matrix}\end{matrix} & 〈 Equation 20 〉\end{matrix}$$

Equation 21 is another exemplary equation for expressing the RIV.

$$RIV ( {S}_{1} , {L}_{1} , {S}_{2} , {L}_{2} ) = {\sum }_{i = 0}^{{S}_{1} - 1} {F}_{i} + {\sum }_{j = 1}^{{L}_{1} - 1} MappingTable ( {S}_{1} , {L}_{1} ) + {RIV}_{2 nd\_cluster} ( {S}_{1} , {L}_{1} , {S}_{2} , {L}_{2} ) - 1 \qquad 〈 Equation 21 〉$$

In Equation 21, Fᵢ denotes the total number of states for a start position of each cluster. By substituting S2=G+(S1+L1), Equation 21 can be replaced with Equation 22.

$$RIV ( {S}_{1} , {L}_{1} , G , {L}_{2} ) = {\sum }_{i = 0}^{{S}_{1} - 1} {F}_{i} + {\sum }_{j = 1}^{{L}_{1} - 1} MappingTable ( {S}_{1} , {L}_{1} ) + {RIV}_{2 nd\_cluster} ( {S}_{1} , {L}_{1} , G + {S}_{1} + {L}_{1} , {L}_{2} ) - 1 \qquad 〈 Equation 22 〉$$

Table 4 is a mapping table which shows the number of states depending on S1 and L1 when a system bandwidth is 20 MHz and an RBG consists of 4 RBs. The mapping table can be determined according to the system bandwidth. Each state can be determined to (N−S1−L1−1)(N−S1−L1)/2 according to S1 and L1.

TABLE 4

| L1/S1 | 0 | 1 | 2 | 3 | 4 | 5 | 6 | 7 | 8 | 9 | 10 | 11 | 12 |
|---|---|---|---|---|---|---|---|---|---|---|---|---|---|
| 1 | 276 | 253 | 231 | 210 | 190 | 171 | 153 | 136 | 120 | 105 | 91 | 78 | 66 |
| 2 | 253 | 231 | 210 | 190 | 171 | 153 | 136 | 120 | 105 | 91 | 78 | 66 | 55 |
| 3 | 231 | 210 | 190 | 171 | 153 | 136 | 120 | 105 | 91 | 78 | 66 | 55 | 45 |
| 4 | 210 | 190 | 171 | 153 | 136 | 120 | 105 | 91 | 78 | 66 | 55 | 45 | 36 |
| 5 | 190 | 171 | 153 | 136 | 120 | 105 | 91 | 78 | 66 | 55 | 45 | 36 | 28 |
| 6 | 171 | 153 | 136 | 120 | 105 | 91 | 78 | 66 | 55 | 45 | 36 | 28 | 21 |
| 7 | 153 | 136 | 120 | 105 | 91 | 78 | 66 | 55 | 45 | 36 | 28 | 21 | 15 |
| 8 | 136 | 120 | 105 | 91 | 78 | 66 | 55 | 45 | 36 | 28 | 21 | 15 | 10 |
| 9 | 120 | 105 | 91 | 78 | 66 | 55 | 45 | 36 | 28 | 21 | 15 | 10 | 6 |
| 10 | 105 | 91 | 78 | 66 | 55 | 45 | 36 | 28 | 21 | 15 | 10 | 6 | 3 |
| 11 | 91 | 78 | 66 | 55 | 45 | 36 | 28 | 21 | 15 | 10 | 6 | 3 | 1 |
| 12 | 78 | 66 | 55 | 45 | 36 | 28 | 21 | 15 | 10 | 6 | 3 | 1 | |
| 13 | 66 | 55 | 45 | 36 | 28 | 21 | 15 | 10 | 6 | 3 | 1 | | |
| 14 | 55 | 45 | 36 | 28 | 21 | 15 | 10 | 6 | 3 | 1 | | | |
| 15 | 45 | 36 | 28 | 21 | 15 | 10 | 6 | 3 | 1 | | | | |
| 16 | 36 | 28 | 21 | 15 | 10 | 6 | 3 | 1 | | | | | |
| 17 | 28 | 21 | 15 | 10 | 6 | 3 | 1 | | | | | | |
| 18 | 21 | 15 | 10 | 6 | 3 | 1 | | | | | | | |
| 19 | 15 | 10 | 6 | 3 | 1 | | | | | | | | |
| 20 | 10 | 6 | 3 | 1 | | | | | | | | | |
| 21 | 6 | 3 | 1 | | | | | | | | | | |
| 22 | 3 | 1 | | | | | | | | | | | |
| 23 | 1 | | | | | | | | | | | | |
| | 2300 | 2024 | 1771 | 1540 | 1330 | 1140 | 969 | 816 | 680 | 560 | 455 | 364 | 286 |
| F(S1) | 2300 | 4324 | 6095 | 7635 | 8965 | 10105 | 11074 | 11890 | 12570 | 13130 | 13585 | 13949 | 14235 |

| L1/S1 | 13 | 14 | 15 | 16 | 17 | 18 | 19 | 20 | 21 | 22 |
|---|---|---|---|---|---|---|---|---|---|---|
| 1 | 55 | 45 | 36 | 28 | 21 | 15 | 10 | 6 | 3 | 1 |
| 2 | 45 | 36 | 28 | 21 | 15 | 10 | 6 | 3 | 1 | |
| 3 | 36 | 28 | 21 | 15 | 10 | 6 | 3 | 1 | | |
| 4 | 28 | 21 | 15 | 10 | 6 | 3 | 1 | | | |
| 5 | 21 | 15 | 10 | 6 | 3 | 1 | | | | |
| 6 | 15 | 10 | 6 | 3 | 1 | | | | | |
| 7 | 10 | 6 | 3 | 1 | | | | | | |
| 8 | 6 | 3 | 1 | | | | | | | |
| 9 | 3 | 1 | | | | | | | | |
| 10 | 1 | | | | | | | | | |
| 11 | | | | | | | | | | |
| 12 | | | | | | | | | | |
| 13 | | | | | | | | | | |
| 14 | | | | | | | | | | |
| 15 | | | | | | | | | | |
| 16 | | | | | | | | | | |
| 17 | | | | | | | | | | |
| 18 | | | | | | | | | | |
| 19 | | | | | | | | | | |
| 20 | | | | | | | | | | |
| 21 | | | | | | | | | | |
| 22 | | | | | | | | | | |
| 23 | | | | | | | | | | |
| | 220 | 165 | 120 | 84 | 56 | 35 | 20 | 10 | 4 | 1 |
| F(S1) | 14455 | 14620 | 14740 | 14824 | 14880 | 14915 | 14935 | 14945 | 14949 | 14950 |

Equation 23 is another exemplary equation for expressing the RIV.

$$RIV ( {S}_{1} , {L}_{1} , {S}_{2} , {L}_{2} ) = {\sum }_{i = 0}^{{S}_{1} - 1} {F}_{i} + {\sum }_{j = 1}^{{L}_{1} - 1} MappingTable ( {S}_{1} , {L}_{1} ) + {RIV}_{2 nd\_cluster} ( {S}_{1} , {L}_{1} , {S}_{2} , {L}_{2} ) \qquad 〈 Equation 23 〉$$

In Equation 23, Fᵢ denotes the total number of states for a start position of each cluster. By substituting S2=G+(S1+L1), Equation 23 can be replaced with Equation 24 below.

$$RIV ( {S}_{1} , {L}_{1} , G , {L}_{2} ) = {\sum }_{i = 0}^{{S}_{1} - 1} {F}_{i} + {\sum }_{j = 1}^{{L}_{1} - 1} MappingTable ( {S}_{1} , {L}_{1} ) + {RIV}_{2 nd\_cluster} ( {S}_{1} , {L}_{1} , G + {S}_{1} + {L}_{1} , {L}_{2} ) \qquad 〈 Equation 24 〉$$

The mapping table of Table 4 can also be used in Equation 23 and Equation 24.

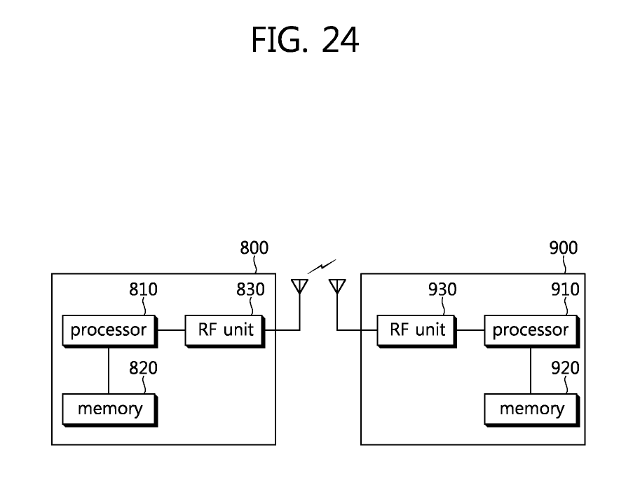

FIG. 24 is a block diagram showing wireless communication system to implement an embodiment of the present invention.

A BS 800 may include a processor 810, a memory 820 and a radio frequency (RF) unit 830. The processor 810 may be configured to implement proposed functions, procedures and/or methods described in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

A UE 900 may include a processor 910, a memory 920 and a RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification is intended to embrace all such alternations, modifications and variations that fall within the spirit and scope of the appended claims.

What is claimed is:

1. A method for allocating an uplink resource in a wireless communication system, the method comprising:
allocating a plurality of clusters which are distributed in a frequency domain to uplink resources by transmitting uplink resource allocation information to a terminal; and
receiving data through the plurality of clusters,
wherein the plurality of clusters is allocated on the basis of at least one of a position of each of the plurality of clusters in the frequency domain and a gap between the plurality of clusters.

2. The method of claim 1, wherein the uplink resource allocation information is included in downlink control information (DCI) transmitted through a physical downlink control channel (PDCCH).

3. The method of claim 2, wherein a resource allocation field of the DCI format includes a resource indication value (RIV), and
wherein the RIV is determined on the basis of at least one of the position of each of the plurality of clusters and the gap between the plurality of clusters.

4. The method of claim 1, wherein the gap between the plurality of clusters is uniform.

5. The method of claim 1, wherein the plurality of clusters are respectively included in a plurality of resource groups, and
wherein the plurality of resource groups are allocated in a uniform specific gap.

6. The method of claim 1, wherein the plurality of clusters are respectively included in a plurality of resource groups,
wherein the plurality of resource groups are included in a plurality of super groups, and
wherein the plurality of super groups are allocated in a uniform specific gap.

7. The method of claim 6, wherein clusters included in any one super group among the plurality of super groups start at the same position in the respective resource groups included in the any one super group.

8. The method of claim 6, wherein clusters included in any one super group among the plurality of super groups have the same length.

9. The method of claim 8, wherein clusters included in different super groups among the plurality of super groups have different lengths.

10. The method of claim 1, wherein the gap between the plurality of clusters is indicated on the basis of a position of any one reference cluster among the plurality of clusters and a position of a cluster allocated next to the reference cluster.

11. The method of claim 1, wherein the number of the plurality of clusters is 2.

12. The method of claim 1, wherein the plurality of clusters are allocated on the basis of length of each of the plurality of clusters.

13. A method of transmitting data in a wireless communication system, the method comprising:
receiving uplink resource allocation information from a base station; and
transmitting data through a plurality of distributed clusters allocated on the basis of the uplink resource allocation information,
wherein the plurality of clusters is allocated on the basis of at least one of a position of each of the plurality of clusters in a frequency domain and a gap between the plurality of clusters.

14. The method of claim 13, wherein the uplink resource allocation information is included in downlink control information (DCI) transmitted on a physical downlink control channel (PDCCH).
